(19) United States
(12) Patent Application Publication
(10) Pub. No.: US 2025/0241296 A1
(43) Pub. Date: Jul. 31, 2025

(54) HIGH-LOAD AGRICULTURAL FORMULATIONS AND METHODS OF MAKING SAME

(71) Applicant: BASF Corporation, Florham Park, NJ (US)

(72) Inventors: Duy Minh LE, Cary, NC (US); Philip M. MATHEW, Morrisville, NC (US)

(73) Assignee: BASF Corporation, Florham Park, NJ (US)

(21) Appl. No.: 18/853,969

(22) PCT Filed: Apr. 17, 2023
(86) PCT No.: PCT/US2023/065844

§ 371 Date: Oct. 3, 2024

Related U.S. Application Data
(60) Provisional application No. 63/332,041, filed on Apr. 18, 2022.

(51) Int. Cl. A01N 25/04; A01N 43/40; A01N 43/653; A01N 43/78; A01P 3/00; A01P 7/04

(52) U.S. Cl. CPC A01N 25/04; A01N 43/40; A01N 43/653; A01N 43/78; A01P 3/00; A01P 7/04

(57) ABSTRACT

Provided are methods of forming agrochemical formulations including (a) homogenizing a first mixture comprising at least one agrochemical active agent in water to form a first homogenized mixture; (b) forming a first mill base by milling the first homogenized mixture; (c) homogenizing a second mixture comprising at least one agrochemical active agent and the first mill base to form a second homogenized mixture; (d) bead milling the second homogenized mixture; (e) homogenizing a third mixture comprising an aqueous surfactant solution and a thickening agent to form a slurry; and (f) combining the slurry with the second mill base to form an agrochemical formulation comprising 57-76% (w/w) of the agrochemical active agent, based on the total weight of the formulation.

### FIELD

The disclosure generally relates to highly concentrated agrochemical formulations and methods of preparing same.

### BACKGROUND

Agrochemical formulations are commonly supplied to the end user as a concentrate which is then diluted for use. Adjuvant and agrochemical actives can be added in the tank mix at the point of dilution. However, preferably the adjuvants and actives are included in the concentrate. When the agrochemical active agent is insoluble or only partly soluble in water, the concentrate comprising the active is conveniently supplied in the form of a suspension concentrate (SC) in which finely divided solid particles of agrochemical are suspended in an aqueous formulation. Wetting agents and dispersants may also be including in the SC to wet and stabilize the solid particles. SC formulations may therefore typically comprise a solid active, surfactant, density/viscosity modifier system, freeze/thaw additive, bactericide, anti-foamer, and water diluent.

It is important that the solid particles remain suspended in the concentrate formulation without significant separation over an extended period of time under typical storage conditions. It is also important to prevent the dispersed solid particles in the SC from forming a hard pack sediment upon storage. It is therefore normally necessary to incorporate suspending or structuring agents into the suspension concentrate. For example, existing structuring agents used for water based SCs include polysaccharide gums, clays, celluloses, polyacrylates, and xanthan gum.

The presence of high loadings of agrochemicals in an SC formulation with consequent reduction in water content present the formulator with major problems including challenges in maintaining the SC formulation in a flowable form. The flowability of the formulation is particularly important for seed treatment formulations, which are typically applied with equipment that pumps the formulations onto the seed.

Therefore, there is a need for agrochemical formulations and methods of producing agrochemical formulations with high concentrations of active agents that can demonstrate suitable viscosities and flowability at the point of use, and which are able to remain stable towards settling, phase separation, and/or agglomeration for a period of time to allow for storage without settling of the solid active agent.

### SUMMARY

Provided herein are methods of forming agrochemical formulations comprising
(a) homogenizing a first mixture comprising at least one agrochemical active agent in water to form a first homogenized mixture;
(b) forming a first mill base by:
   (i) bead milling the first homogenized mixture to form first particles having a D90 particle size of about 1-75 microns; or
   (ii) colloid milling the first homogenized mixture to form first particles having a D50 particles size of about 1-75 microns;
(c) homogenizing a second mixture comprising at least one agrochemical active agent and the first mill base to form a second homogenized mixture;
(d) bead milling the second homogenized mixture to form a second mill base including second particles having a D90 particles size of about 1-75 microns;
(e) homogenizing a third mixture comprising an aqueous surfactant solution and a thickening agent to form a slurry; and
(f) combining the slurry with the second mill base to form an agrochemical formulation comprising 57-76% (w/w) of the agrochemical active agent, based on the total weight of the formulation, thereby forming the agrochemical formulation;
   wherein, the first mixture comprises 20-70% (w/w) of the at least one agrochemical active agent with the balance including water and optionally a surfactant, an antifreeze, a biocide, an antifoaming agent, or a combination thereof; and the second mixture comprises 10-50% (w/w) of the at least one agrochemical active agent, based on the total weight of the second mixture.

Further provided herein are agrochemical formulations comprising about 57 to about 76% (w/w) of at least one agrochemical active agent, based on the total weight of the formulation, dispersed in a mixture of water, an aqueous surfactant, and thickening agent, wherein the agrochemical formulation is in the form of a shear thinning gel.

Further provided herein is an article for dispensing an agrochemical formulation of the disclosure comprising a container fitted with an agitator blade and the agrochemical formulation of the disclosure provided in the container and in contact with the agitator blade, wherein the agitator lade is configured to facilitate a phase transition of the agrochemical formulation from a gel to a flowable fluid.

Further provided herein are kits comprising a container fitted with an agitator blade and the agrochemical formulation of the disclosure.

Further provided herein are methods of treating a substrate with an agrochemical formulation of the disclosure, comprising providing an agrochemical formulation of the disclosure, agitating the agrochemical formulation to facilitate a phase transition of the agrochemical formulation from a gel to a flowable fluid, and applying the flowable fluid to the substrate.

Further aspects and advantages will be apparent to those of ordinary skill in the art from a review of the following detailed descriptions. While the compositions and methods are susceptible of embodiments in various forms, the description hereafter includes specific embodiments with the understanding that the disclosure is illustrative and is not intended to limit the invention to the specific embodiments described herein.

### BRIEF DESCRIPTION OF THE DRAWINGS

For further facilitating the understanding of the present invention, drawing figures are appended hereto.

FIG. 1 demonstrates the syneresis after storage for 6 months of two agrochemical formulations not of the disclosure (Formulation A and Formulation B) and a formulation of the disclosure (Example 2).

FIG. 2 demonstrates the viscosity after agitation of two agrochemical formulations not of the disclosure (Formulation A and Formulation B) and a formulation of the disclosure (Example 2).

FIGS. 3 and 4 demonstrate the viscosity and syneresis results for four agrochemical formulations not of the disclosure (Formulations A, C, D, and E) and a formulation of the disclosure (Example 5 Formulation).

FIG. 5 demonstrates the storage modulus (G′) data for one agrochemical formulation not of the disclosure (Formulation D) and a formulation of the disclosure (Example 5 Formulation).

### DETAILED DESCRIPTION

Provided herein are agrochemical formulations, methods of forming agrochemical formulations, methods of using agrochemical formulations, and articles and kits including agrochemical formulations. The agrochemical formulations of the disclosure can have one or more advantageous including, but not limited to, providing agrochemical formulations with high concentrations of agrochemical active agents, providing a gelled agrochemical composition that can maintain the solid agrochemical active agents dispersed throughout the composition, thereby preventing settling of the active agent over time, and/or providing an agrochemical formulation in a stable form that can revert to a flowable form when needed for application to a substrate.

The disclosure provides agrochemical formulations comprising a dispersion comprising at least about 57 to about 76% (w/w) of at least one agrochemical active agent, based on the total weight of the formulation, dispersed in a mixture of water, an aqueous surfactant, and a thickening agent, wherein the agrochemical formulation is in the form of a shear thinning gel.

The term “about” is used according to its ordinary meaning, for example, to mean approximately or around. In one embodiment, the term “about” means±10% of a stated value or range of values. In another embodiment, the term “about” means±5% of a stated value or range of values. A value or range described in combination with the term “about” expressly includes the specific value and/or range as well (e.g., for a value described as “about 40,” “40” is also expressly contemplated).

All percentages, parts and ratios referred to herein are based upon measurements made at about 25° C., unless otherwise specified. All such weights as they pertain to listed ingredients are based on the ingredient level and therefore do not include carriers or by-products that may be included in commercially available materials, unless otherwise specified.

All ranges set forth herein include all possible subsets of ranges and any combinations of such subset ranges. By default, ranges are inclusive of the stated endpoints, unless stated otherwise. Where a range of values is provided, it is understood that each intervening value between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also contemplated to be part of the disclosure.

It is expressly contemplated that for any number value described herein, e.g. as a parameter of the subject matter described or part of a range associated with the subject matter described, an alternative which forms part of the description is a functionally equivalent range surrounding the specific numerical value (e.g. for a dimension disclosed as “40 microns” an alternative embodiment contemplated is “about 40 microns”).

“Comprising” as used herein means that various components, ingredients or steps can be conjointly employed in practicing the present disclosure. Accordingly, the term “comprising” encompasses the more restrictive terms “consisting essentially of” and “consisting of.” The present compositions can comprise, consist essentially of, or consist of any of the required and optional elements disclosed herein. The invention illustratively disclosed herein suitably may be practiced in the absence of any element or step which is not specifically disclosed herein.

The terms “dispersed,” “dispersion,” and other iterations thereof are used according to their ordinary meaning of a two-phase system comprising a disperse phase in a dispersion medium. In the formulations of the disclosure, the disperse phase comprises solid agrochemical active agents and the dispersion medium comprises water. The dispersion medium can optionally include other components dissolved in water, including but not limited to, surfactants, antifoaming agents, biocides, antifreeze, and thickening agents.

As used herein, the term “shear thinning” is used according to its ordinary meaning of a material having non-Newtonian behavior wherein the viscosity of the material decreases under shear strain. As used herein, the term “gel” is used according to its ordinary meaning of a semisolid material.

As used herein, and unless specified otherwise, a “flowable fluid” refers to a composition having a viscosity of about 2000 cP or less. In general, the composition can be a solution, suspension, or other mixture.

### Agrochemical Active Agent

The agrochemical active agent can generally be any chemical or combination of chemicals useful in agriculture, including, but not limited to insecticides, herbicides, fungicides, algaecides, rodenticides, molluscicides, nematicides, fertilizers, soil conditioners, liming and acidifying agents, and plant growth regulators. In embodiments, the agrochemical active agent comprises an insecticide, an herbicide, a fungicide, an algaecide, a rodenticide, a molluscicide, a nematicide, or a combination thereof. In embodiments, the agrochemical active agent comprises an insecticide, an herbicide, a fungicide, or a combination thereof. In embodiments, the agrochemical active agent comprises an insecticide, a fungicide, or a combination thereof.

In some embodiments, the active agent has a density in a range of about 0.5 and about 2.5 g/mL, in a range of about 0.5 and about 2.0 g/mL, in a range of about 0.5 and about 1.5 g/mL, in a range of about 0.75 and about 2.5 g/mL, in a range of about 0.75 and about 2.0 g/mL, in a range of about 0.75 and about 1.5 g/mL, in a range of about 1.0 and about 2.5 g/mL, in a range of about 1.0 and about 2.0 g/mL, or in a range of about 1.0 and about 1.5 g/mL. In embodiments, the active agent has a density in a range of about 1.0 and about 2.0 g/mL.

In some embodiments, the active agent has a melting point above about 50° C., above about 75° C., above about 100° C., above about 125° C., above about 150° C., or above about 175° C. In embodiments, the active agent has a melting point above about 50° C. In embodiments, the active agent has a melting point above about 100° C. In some embodiments, the active agent has a melting point in a range of about 50° C. and about 200° C., about 50° C. and about 175° C., about 50° C. and about 150° C., about 75° C. and about 200° C., about 75° C. and about 175° C., about 75° C. and about 150° C., about 100° C. and about 200° C., or about 100° C. and about 175° C. In one aspect, the active agent has a melting point between about 50° C. and about 200° C. In another aspect, the active agent has a melting point between about 100° C. and about 200° C.

In some embodiments, the active agent has a solubility in water of less than about 2000 mg/L, less than about 1750 mg/L, less than about 1500 mg/L, less than about 1250 mg/L, less than about 1000 mg/L, less than about 750 mg/L, less than about 500 mg/L, less than about 250 mg/L, or less than about 100 mg/L. In embodiments, the active agent has a solubility in water of less than about 1000 mg/L. In embodiments, the active agent has a solubility in water of less than about 100 mg/L.

In some embodiments, the active agent has a solubility in water in a range of about 0.01 mg/L and about 2000 mg/L, about 0.01 mg/L and about 1750 mg/L, about 0.01 mg/L and about 1500 mg/L, about 0.01 mg/L and about 1250 mg/L, about 0.01 mg/L and about 1000 mg/L, about 0.01 mg/L and about 750 mg/L, about 0.01 mg/L and about 500 mg/L, about 0.01 mg/L and about 250 mg/L, or about 0.01 mg/L and about 100 mg/L. In embodiments, the active agent has a solubility in water of less than about 1000 mg/L. In embodiments, the active agent has a solubility in water in a range of about 0.01 mg/L and about 1000 mg/L. In some embodiments, the active agent has a solubility in water in a range of about 0.01 mg/L and about 100 mg/L.

In some embodiments, the active agent in the agrochemical formulation can be a fungicide. In certain embodiments, the fungicide can be a triazole fungicide. In one embodiment, the triazole fungicide is selected from the group consisting of azacona-zole, bitertanol, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, mefentrifluconazole, metconazole, myclobutanil, paclobutrazol, penconazole, propiconazole, prothioconazole, quinconazole, simeconazole, tebucona-zole, tetraconazole, triadimefon, triadimenol, triticonazole, uniconazole, uniconazole-P, voriconazole, and 1-(4-chloro-pheny1)-2-(1H-1,2,4-triazol-1-yl)cycloheptanol.

In another embodiment, the fungicide can be a strobilurin fungicide. In one embodiment, the triazole fungicide is selected from the group consisting of trifloxystrobin, dimoxystrobin, fluoxastrobin, pyraclostrobin, enestroburin, picoxystrobin, azoxystrobin and mandestrobin.

The fungicide may be selected from any one of the following:

1) Inhibitors of the ergosterol biosynthesis, for example (1.001) cyproconazole, (1.002) difenoconazole, (1.003) epoxiconazole, (1.004) fenhexamid, (1.005) fenpro-pidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothio-conazole, (1.019) Pyrisoxazole, (1.020) spiroxamine, (1.021) tebuconazole, (1.022) tetraconazole, (1.023) triadi-menol, (1.024) tridemorph, (1.025) triticonazole, (1.026) (1R,2 S,55)-5-(4-chlorobenzy1)-2-(chloromethyl)-2-methyl-1-(1H-1,2,4-triazol-1-ylmethyl)-cyclo-pentanol, (1.027) (1S,2R,5R)-5-(4-chlorobenzy1)-2-(chloromethyl)-2-methyl-1-(1H-1,2,4-triazol-1-ylmethyl)cyclopentanol, (1.028) (2R)-2-(1-chlorocyclopropy1)-4-[(1R)-2,2-dichlorocyclopropyl]-1-(1H-1,2,4-triazol-1-yl)butan-2-ol, (1.029) (2R)-2-(1-chlorocyclopropyl)-4-[1(1 S)-2,2-dichlorocyclopropyl]-1-(1H-1,2,4-triazol-1-yl)butan-2-ol, (1.030) (2R)-2-[4-(4-chlorophenoxy)-2-(trifluoromethyl)pheny1]-1-(1H-1,2,4-triazol-1-yl)-propan-2-ol, (1.031) (2S)-2-(1-chlorocyclopropy1)-4-[(1R)-2,2-dichlorocyclopropyl]-1-(1H-1,2,4-triazol-1-y1)butan-2-ol, (1.032) (2 S)-2-(1-chlorocyclopropy1)-4-[(1S)-2,2-dichlorocyclopropyl]-1-(1H-1,2,4-triazol-1-yl)butan-2-ol, (1.033) (25)-2-[4-(4-chlorophenoxy)-2-(trifluoromethyl)pheny1]-1-(1H-1,2,4-triazol-1-yl)propan-2-ol, (1.034) (R)-[3-(4-chloro-2-fluoropheny1)-5-(2,4-difluoropheny1)-1,2-oxazol-4-yl](pyridin-3-yl)methanol, (1.035) (S)-[3-(4-chloro-2-fluoropheny1)-5-(2,4-difluoropheny1)-1,2-oxazol-4-yl](pyridin-3-yl)methanol, (1.036) [3-(4-chloro-2-fluoropheny1)-5-(2,4-difluoropheny1)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chloropheny1)-2-(2,4-difluoro-phenyl)oxiran-2-yl]methyl}-1H-1,2,4-triazol-5-yl thiocyanate, (1.041) 1-{[rel (2R,3S)-3-(2-chloropheny1)-2-(2,4-difluorophenyl)oxiran-2-yl]methyl}-1H-1,2,4-triazol-5-yl thiocyanate, (1.042) 2-[(2R,4R,5R)-1-(2,4-dichloropheny1)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2, 4-dihydro-3H-1,2,4-triazole-3-thione, (1.048) 2-[(2S,4S,5R)-1-(2,4-dichlorophenyl)-5-hydroxy-2,6,6-trimethyl-heptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) Mefentrifluconazole, (1.056) 2-{[3-(2-chlorophenyl)-2-(2, 4-difluorophenyl)oxiran-2-yl]methyl}-2,4-dihydro-3H-1,2, 4-triazole-3-thione, (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)-oxiran-2-yl]methyl}-2,4-dihydro-3H-1,2,4-triazole-3-thione, (1.059) 5-(4-chlorobenzyl)-2-(chloromethyl)-2-methyl-1-(1H-1,2, 4-triazol-1-ylmethyl)cyclopentanol, (1.060) 5-(allyl-sulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel (2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)-phenyl]sulfanyl}phenyl)-N-ethyl-N-methylimidoformamide, (1.067) N′-(2,5-dimethyl-4-{3-[(1, 1,2,2-tetrafluoroethyl)sulfanyl]phenoxy}pheny1)-N-ethyl-N-methylimidoformamide, (1.068) N′-(2,5-dimethyl-4-{3-[(2,2,2-trifluoroethyl)sulfanyl]phenoxy}phenyl)-N-ethyl-N-methylimido-formamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)-sulfanyl]phenoxy}phenyl)-N-ethyl-N-methylimidoformamide, (1.071) N′-(2,5-dimethyl-4-phenoxy-phenyl)-N-ethyl-N-methylimidoformamide, (1.072) N′-(4-1[3-(difluoromethoxy)-phenyl]-sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) Ipfentrifluconazole.

2) Inhibitors of the respiratory chain at complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1 RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026)2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) 3-(difluoromethyl)-1-methyl-N-[(3R)-1,1,3-trimethyl-2,3-dihydro-l1H-inden-4-yl]-1H-pyrazole-4-carboxamide, (2.029) 3-(difluoromethyl)-1-methyl-N-[(3S)-1,1,3-trimethyl-2,3-dihydro-1H-inden-4-yl]-1H-pyrazole-4-carboxamide, (2.030) Fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}-phenyl)ethyl]quinazolin-4-amine, (2.034)N-(2-cyclopentyl-5-fluorobenzyl)-N-cyclopropyl-3-(difluoromethyl)-5-fluoro-1-methyl-1H-pyrazole-4-carboxamide, (2.035)N-(2-tert-butyl-5-methylbenzyl)-N-cyclopropyl-3-(difluoromethyl)-5-fluoro-1-methyl-1H-pyrazole-4-carboxamide, (2.036)N-(2-tert-butylbenzyl)-N-cyclopropyl-3-(difluoromethyl)-5-fluoro-1-methyl-1H-pyrazole-4-carboxamide, (2.037)N-(5-chloro-2-ethylbenzy1)-N-cyclopropyl-3-(difluoromethyl)-5-fluoro-1-methyl-1H-pyrazole-4-carboxamide, (2.038) isoflucypram, (2.039)N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041)N-[1-(2,4-dichlorophenyl)-1-methoxypropan-2-yl]-3-(difluoromethyl)-1-methyl-1H-pyrazole-4-carboxamide, (2.042)N-[2-chloro-6-(trifluoromethyl)benzyl]-N-cyclopropyl-3-(difluoromethyl)-5-fluoro-1-methyl]-1H-pyrazole-4 carboxamide, (2.043)N-[3-chloro-2-fluoro-6-(trifluoromethyl)benzyl]-N-cyclo-propyl-3-(difluoromethyl)-5-fluoro-1-methyl-1H-pyrazole-4-carboxamide, (2.044)N-[5-chloro-2-(trifluoromethyl)benzyl]-N-cyclopropyl-3-(difluoromethyl)-5-fluoro-1-methyl-1H-pyrazole-4-carboxamide, (2.045)N-cyclopropyl-3-(difluoromethyl)-5-fluoro-1-methyl-N-[5-methyl-2-(trifluoromethyl)benzyl]-1H-pyrazole-4-carboxamide, (2.046)N-cyclopropyl-3-(difluoromethyl)-5-fluoro-N-(2-fluoro-6-isopropylbenzyl)-1-methyl-1H-pyrazole-4-carboxamide, (2.047)N-cyclopropyl-3-(difluoromethyl)-5-fluoro-N-(2-isopropyl-5-methylbenzyl)-1-methyl-1H-pyrazole-4-carboxamide, (2.048)N-cyclopropyl-3-(difluoromethyl)-5-fluoro-N-(2-isopropylbenzyl)-1-methyl-1H-pyrazole-4-carbothioamide, (2.049)N-cyclopropyl-3-(difluoromethyl)-5-fluoro-N-(2-isopropylbenzyl)-1-methyl-1H-pyrazole-4-carboxamide, (2.050)N-cyclopropyl-3-(difluoromethyl)-5-fluoro-N-(5-fluoro-2-isopropylbenzyl)-1-methyl-1H-pyrazole-4-carboxamide, (2.051)N-cyclopropyl-3-(difluoromethyl)-N-(2-ethyl-4,5-dimethylbenzyl)-5-fluoro-1-methyl-1H-pyrazole-4-carboxamide, (2.052)N-cyclopropyl-3-(difluoromethyl)-N-(2-ethyl-5-fluorobenzyl)-5-fluoro-1-methyl-1H-pyrazole-4-carboxamide, (2.053)N-cyclopropyl-3-(difluoromethyl)-N-(2-ethyl-5-methylbenzyl)-5-fluoro-1-methyl-1H-pyrazole-4-carboxamide, (2.054)N-cyclopropyl-N-(2-cyclopropyl-5-fluorobenzyl)-3-(difluoromethyl)-5-fluoro-1-methyl-1H-pyrazole-4-carboxamide, (2.055)N-cyclopropyl-N-(2-cyclopropyl-5-methylbenzyl)-3-(difluoromethyl)-5-fluoro-1-methyl-1H-pyrazole-4-carboxamide, (2.056)N-cyclopropyl-N-(2-cyclopropylbenzyl)-3-(difluoromethyl)-5-fluoro-1-methyl-1H-pyrazole-4-carboxamide, (2.057) pyrapropoyne.

3) Inhibitors of the respiratory chain at complex Ill, for example (3.001) ametoctradin, (3.002) amisulbrom, (3.003) azoxystrobin, (3.004) coumethoxystrobin, (3.005) coumoxystrobin, (3.006) cyazofamid, (3.007) dimox-ystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (3.026) mandestrobin, (3.027)N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid.

4) Inhibitors of the mitosis and cell division, for example (4.001) carbendazim, (4.002) diethofencarb, (4.003) ethaboxam, (4.004) fluopicolide, (4.005) pencycuron, (4.006) thiabendazole, (4.007) thiophanatemethyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dim-ethylpyridazine, (4.023)N-(2-bromo-6-fluorophenyl)-4-(2-chloro-4-fluorophenyl)-1,3-dimethyl-1H-pyrazol-5-amine, (4.024)N-(2-bromophenyl)-4-(2-chloro-4-fluorophenyl)-1,3-dimethyl-1H-pyrazol-5-amine, (4.025)N-(4-chloro-2,6-difluorophenyl)-4-(2-chloro-4-fluorophenyl)-1,3-dimethyl-1H-pyrazol-5-amine.

5) Compounds capable to have a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino [2,3-c][1,2]thiazole-3-carbonitrile.

6) Compounds capable to induce a host defense, for example (6.001) acibenzolar-S-methyl, (6.002) isotianil, (6.003) probenazole, (6.004) tiadinil.

7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline.

8) Inhibitors of the ATP production, for example (8.001) silthiofam.

9) Inhibitors of the cell wall synthesis, for example (9.001) benthiavalicarb, (9.002) dimethomorph, (9.003) flu-morph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4 yl)prop-2-en-1-one.

10) Inhibitors of the lipid and membrane synthesis, for example (10.001) propamocarb, (10.002) propamocarb hydrochloride, (10.003) tolclofos-methyl.

11) Inhibitors of the melanin biosynthesis, for example (11.001) tricyclazole, (11.002) 2,2,2-trifluoroethyl {3-methyl-1-[(4-methylbenzoyl)amino]butan-2-yl}carbamate.

12) Inhibitors of the nucleic acid synthesis, for example (12.001) benalaxyl, (12.002) benalaxyl-M (kiralaxyl), (12.003) metalaxyl, (12.004) metalaxyl-M (mefenoxam).

13) Inhibitors of the signal transduction, for example (13.001) fludioxonil, (13.002) iprodione, (13.003) procymidone, (13.004) proquinazid, (13.005) quinoxyfen, (13.006) vinclozolin.

14) Compounds capable to act as an uncoupler, for example (14.001) fluazinam, (14.002) meptyldinocap.

15) Further compounds, for example (15.001) Abscisic acid, (15.002) benthiazole, (15.003) bethoxazin, (15.004) capsimycin, (15.005) carvone, (15.006) chinome-thionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)-piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]-ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) lpflufenoquin, (15.042) 2-{2-fluoro-6-[(8-fluoro-2-methylquinolin-3-yl)oxy]phenyl}propan-2-ol, (15.043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenylmethanesulfonate, (15.045) 2-phenylphenol and salts, (15.046) 3-(4,4,5-trifluoro-3,3-dimethyl-3,4-dihydroisoquinolin-1-yl) quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N‘-phenyl-N’-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)-oxy]-pyrimidin-4-amine, (15.054) 9-fluoro-2,2-dimethyl-5-(quinolin-3-yl)-2,3-dihydro-1,4-benzoxazepine, (15.055) but-3-yn-1-yl{6-[({[(Z)-(1-methyl-1H-tetrazol-5-yl)-(phenyl)-methylene]amino}oxy) methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}-carbamate, (15.062) 5-fluoro-4-imino-3-methyl-1-[(4-methylphenyl)sulfonyl]-3,4-dihydropyrimidin-2(1H)-one, (15.063) aminopyrifen.

All named mixing partners of the classes (1) to (15) as described here above can be present in the form of the free compound and/or, if their functional groups enable this, an agriculturally acceptable salt thereof.

In other aspects, the active agent in the agrochemical formulation is an insecticide. The insecticide may be selected from any one of the following:

(1) Acetylcholinesterase (AChE) inhibitors, such as, for example, carbamates, for example alanycarb, aldi-carb, bendiocarb, benfuracarb, butocarboxim, butoxycarboxim, carbaryl, carbofuran, carbosulfan, ethiofencarb, fenobucarb, formetanate, furathiocarb, isoprocarb, methio-carb, methomyl, metolcarb, oxamyl, pirimicarb, propoxur, thiodicarb, thiofanox, triazamate, trimethacarb, XMC and xylylcarb; or organophosphates, for example acephate, azamethiphos, azinphos-ethyl, azinphos-methyl, cadusafos, chlorethoxyfos, chlorfenvinphos, chlormephos, chlorpyri-fos-methyl, coumaphos, cyanophos, demeton-S-methyl, diazinon, dichlorvos/DDVP, dicrotophos, dimethoate, dim-ethylvinphos, disulfoton, EPN, ethion, ethoprophos, fam-phur, fenamiphos, fenitrothion, fenthion, fosthiazate, hep-tenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, teme-phos, terbufos, tetrachlorvinphos, thiometon, triazophos, triclorfon and vamidothion.

(2) GABA-gated chloride channel blockers, such as, for example, cyclodiene-organochlorines, for example chlordane and endosulfan or phenylpyrazoles (fiproles), for example ethiprole and fipronil.

(3) Sodium channel modulators, such as, for example, pyrethroids, e.g., acrinathrin, allethrin, d-cis-trans allethrin, d-trans allethrin, bifenthrin, bioallethrin, bioalle-thrin s-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans-isomer], deltamethrin, empenthrin [(EZ)-(1R)-isomer], esfenvalerate, etofenprox, fenpropath-rin, fenvalerate, flucythrinate, flumethrin, tau-fluvalinate, halfenprox, imiprothrin, kadethrin, momfluorothrin, perme-thrin, phenothrin [(1R)-trans-isomer], prallethrin, pyrethrins (pyrethrum), resmethrin, silafluofen, tefluthrin, tetramethrin, tetramethrin [(1R)-isomer)], tralomethrin and transfluthrin or DDT or methoxychlor.

(4) Nicotinic acetylcholine receptor (nAChR) competitive modulators, such as, for example, neonicotinoids, e.g., acetamiprid, clothianidin, dinotefuran, imidacloprid, nitenpyram, thiacloprid and thiamethoxam or nicotine or sulfoxaflor or flupyradifurone.

(5) Nicotinic acetylcholine receptor (nAChR) allosteric modulators, such as, for example, spinosyns, e.g., spinetoram and spinosad.

(6) Glutamate-gated chloride channel (GluCI) allosteric modulators, such as, for example, avermectins/milbemycins, for example abamectin, emamectin benzoate, lepimectin and milbemectin.

(7) Juvenile hormone mimics, such as, for example, juvenile hormone analogues, e.g., hydroprene, kinoprene and methoprene or fenoxycarb or pyriproxyfen.

(8) Miscellaneous non-specific (multi-site) inhibitors, such as, for example, alkyl halides, e.g., methyl bromide and other alkyl halides; or chloropicrine or sulphuryl fluoride or borax or tartar emetic or methyl isocyanate generators, e.g., diazomet and metam.

(9) Modulators of Chordotonal Organs, such as, for example pymetrozine or flonicamid.

(10) Mite growth inhibitors, such as, for example clofentezine, hexythiazox and diflovidazin or etoxazole.

(11) Microbial disruptors of the insect gut membrane, such as, for example Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and B.t. plant proteins: CrylAb, CrylAc, CrylFa, Cry1A.105, Cry2Ab, Vip3A, mCry3A, Cry3Ab, Cry3Bb, Cry34Abl/35Abl.

(12) Inhibitors of mitochondrial ATP synthase, such as, ATP disruptors such as, for example, diafenthiuron or organotin compounds, for example azocyclotin, cyhexatin and fenbutatin oxide or propargite or tetradifon.

(13) Uncouplers of oxidative phosphorylation via disruption of the proton gradient, such as, for example, chlorfenapyr, DNOC and sulfluramid.

(14) Nicotinic acetylcholine receptor channel blockers, such as, for example, bensultap, cartap hydrochloride, thiocylam, and thiosultap-sodium.

(15) Inhibitors of chitin biosynthesis, type 0, such as, for example, bistrifluron, chlorfluazuron, diflubenzuron, flucycloxuron, flufenoxuron, hexaflumuron, lufenuron, novaluron, noviflumuron, teflubenzuron and triflumuron.

(16) Inhibitors of chitin biosynthesis, type 1, for example buprofezin.

(17) Moulting disruptor (in particular for Diptera, i.e., dipterans), such as, for example, cyromazine

(18) Ecdysone receptor agonists, such as, for example, chromafenozide, halofenozide, methoxyfenozide and tebufenozide.

(19) Octopamine receptor agonists, such as, for example, amitraz.

(20) Mitochondrial complex Ill electron transport inhibitors, such as, for example, hydramethylnone or acequinocyl or fluacrypyrim.

(21) Mitochondrial complex I electron transport inhibitors, such as, for example from the group of the METI acaricides, e.g., fenazaquin, fenpyroximate, pyrimidifen, pyridaben, tebufenpyrad and tolfenpyrad or rotenone (Derris).

(22) Voltage-dependent sodium channel blockers, such as, for example indoxacarb or metaflumizone.

(23) Inhibitors of acetyl CoA carboxylase, such as, for example, tetronic and tetramic acid derivatives, e.g., spirodiclofen, spiromesifen and spirotetramat.

(24) Mitochondrial complex IV electron transport inhibitors, such as, for example, phosphines, e.g., aluminium phosphide, calcium phosphide, phosphine and zinc phosphide or cyanides, e.g., calcium cyanide, potassium cyanide and sodium cyanide.

(25) Mitochondrial complex II electron transport inhibitors, such as, for example, beta-ketonitrile derivatives, e.g., cyenopyrafen and cyflumetofen and carboxanilides, such as, for example, pyflubumide.

(28) Ryanodine receptor modulators, such as, for example, diamides, e.g., chlorantraniliprole, cyantranilip-role and flubendiamide.

Further active compounds such as, for example, Afidopyropen, Afoxolaner, Azadirachtin, Benclothiaz, Benzoximate, Bifenazate, Broflanilide, Bromopropylate, Chi-nomethionat, Chloroprallethrin, Cryolite, Cyclaniliprole, Cycloxaprid, Cyhalodiamide, Dicloromezotiaz, Dicofol, epsilon-Metofluthrin, epsilon-Momfluthrin, Flometoquin, Fluazaindolizine, Fluensulfone, Flufenerim, Flufenoxystrobin, Flufiprole, Fluhexafon, Fluopyram, Fluralaner, Fluxametamide, Fufenozide, Guadipyr, Heptafluthrin, Imidaclothiz, Iprodione, kappa-Bifenthrin, kappa-Tefluthrin, Lotilaner, Meperfluthrin, Paichongding, Pyridalyl, Pyrifluquinazon, Pyriminostrobin, Spirobudiclofen, Tetrameth-ylfluthrin, Tetraniliprole, Tetrachlorantraniliprole, Tigolaner, Tioxazafen, Thiofluoximate, Triflumezopyrim and iodomethane; furthermore preparations based on Bacillus firmus (1-1582, BioNeem, VOTIVO®), and also the following compounds: 1-{2-fluoro-4-methyl-5-[(2,2,2-trifluoroethyl)sulphinyl]phenyl}-3-(trifluoromethyl)-1H-1,2,4-triazole-5-amine (known from WO 2006/043635) (CAS 885026-50-6), {1′-[(2E)-3-(4-chlorophenyl)prop-2-en-1-yl]-5-fluorospiro[indol-3,4′-piperidin]-1(2H)-yl}(2-chloropyridin-4-yl)methanone (known from WO 2003/106457) (CAS 637360-23-7), 2-chloro-N-[2-{1-[(2E)-3-(4-chlorophenyl)prop-2-en-1-yl]piperidin-4-yl}-4-(trifluoromethyl)phenyl]isonicotinamide (known from WO 2006/003494) (CAS 872999-66-1), 3-(4-chloro-2,6-dimeth-ylphenyl)-4-hydroxy-8-methoxy-1,8-diazaspiro [4,5] dec-3-en-2-one (known from WO 2010/052161) (CAS 1225292-17-0), 3-(4-chloro-2,6-dimethylphenyl)-8-methoxy-2-oxo-1,8-diazaspiro [4.5]dec-3-en-4-yl ethyl carbonate (known from EP 2647626) (CAS 1440516-42-6), 4-(but-2-yn-1-yloxy)-6-(3,5-dimethylpiperidin-1-yl)-5-fluoropyrimidine (known from WO 2004/099160) (CAS 792914-58-0), PF1364 (known from JP 2010/018586) (CAS 1204776-60,2), N-[(2E)-1-[(6-chloropyridin-3-yl)methyl]pyridin-2(1H)-ylidene]-2,2,2-trifluoroacetamide (known from WO 2012/029672) (CAS 1363400-41-2), (3E)-3-[1-[(6-chloro-3-pyridyl)methyl]-2-pyridylidene]-1,1,1-trifluoro-propan-2-one (known from WO 2013/144213) (CAS 1461743-15-6), N-[3-(benzylcarbamoyl)-4-chlorophenyl]-1-methyl-3-(pentafluoroethyl)-4-(trifluoromethyl)-1H-pyrazole-5-carboxamide (known from WO 2010/051926) (CAS 1226889-14-0), 5-bromo-4-chloro-N-[4-chloro-2-methyl-6-(methylcarbamoyl)phenyl]-2-(3-chloro-2-pyridyl)pyrazole-3-carboxamide (known from CN 103232431) (CAS 1449220-44-3), 4-[5-(3,5-dichlorophenyl)-4,5-dihydro-5-(trifluoromethyl)-3-isoxazolyl]-2-methyl-N-(cis-1-oxido-3-thietanyl)-benzamide, 4-[5-(3,5-dichlorophenyl)-4,5-dihydro-5-(trifluoromethyl)-3-isoxazolyl]-2-methyl-N-(trans-1-oxido-3-thietanyl)-benzamide and 4-[(5S)-5-(3,5-dichlorophenyl)-4,5-dihydro-5-(trifluoromethyl)-3-isoxazolyl]-2-methyl-N-(cis-1-oxido-3-thietanyl)benzamide (known from WO 2013/050317 A1) (CAS 1332628-83-7), N-[3-chloro-1-(3-pyridinyl)-1H-pyrazol-4-yl]-N-ethy1-3-[(3,3,3-trifluoropropyl)sulfinyl]-propanamide, (+)-N-[3-chloro-1-(3-pyridinyl)-1H-pyrazol-4-yl]-N-ethyl-3-[(3,3,3-trifluoropropyl)sulfinyl]-propanamide and (−)-N-[3-chloro-1-(3-pyridinyl)-1H-pyrazol-4-yl]-N-ethyl-3-[(3,3,3-trifluoropropyl)sulfinyl]-propanamide (known from WO 2013/162715 A2, WO 2013/162716 A2, US 2014/0213448 A1) (CAS 1477923-37-7), 5-[[(2E)-3-chloro-2-propen-1-yl]amino]-1-[2,6-dichloro-4-(trifluoromethyl)phenyl]-4-[(trifluoromethyl)sulfinyl]-1H-pyrazole-3-carbonitrile (known from CN 101337937 A) (CAS 1105672-77-2), 3-bromo-N-[4-chloro-2-methyl-6-[(methylamino)thioxomethyl]phenyl]-1-(3-chloro-2-pyridinyl)-1H-pyrazole-5-carboxamide, (Liudaibenjiaxuanan, known from CN 103109816 A) (CAS 1232543-85-9); N-[4-chloro-2-[[(1,1-dimethylethyl)amino]carbonyl]-6-methylphenyl]-1-(3-chloro-2-pyridinyl)-3-(fluoromethoxy)-1H-Pyrazole-5-carboxamide (known from WO 2012/034403 A1) (CAS 1268277-22-0), N-[2-(5-amino-1,3,4-thiadiazol-2-yl)-4-chloro-6-methylphenyl]-3-bromo-1-(3-chloro-2-pyridinyl)-1H-pyrazole-5-carboxamide (known from WO 2011/085575 A1) (CAS 1233882-22-8), 4[3-[2,6-dichloro-4-[(3,3-dichloro-2-propen-1-yl)oxy]phenoxy]propoxy]-2-methoxy-6-(trifluoromethyl)-pyrimidine (known from CN 101337940 A) (CAS 110818452-6); (2E)- and 2(Z)-2-[2-(4-cyanophenyl)-1-[3-(trifluoromethyl)phenyl]ethylidene]-N-[4-(difluoromethoxy)phenyl]-hydrazinecarboxamide (known from CN 101715774 A) (CAS 1232543-85-9); 3-(2,2-dichloroethenyl)-2,2-dimethyl-4-(1H-benzimidazol-2-yl)phenyl-cyclopropanecarboxylic acid ester (known from CN 103524422 A) (CAS 1542271-46-4); (4aS)-7-chloro-2,5-dihydro-2-[[(methoxycarbonyl)[4-[(trifluoromethyl)thio]phenyl]amino]carbonyl]-indeno[1,2-e][1,3,4]oxadiazine-4a (3H)-carboxylic acid methyl ester (known from CN 102391261 A) (CAS 1370358-69-2); 6-deoxy-3-O-ethyl-2,4-di-O-methyl-, 1-[N-[4-[1-[4-(1,1,2,2,2-pentafluoroethoxy)phenyl]-1H-1,2,4-triazol-3-yl]phenyl]carbamate]-α-L-mannopyranose (known from US 2014/0275503 A1) (CAS 1181213-14-8); 8-(2-cyclopropylmethoxy-4-trifluoromethyl-phenoxy)-3-(6-trifluoromethyl-pyridazin-3-yl)-3-aza-bicyclo[3.2.1]octane (CAS 1253850-56-4), (8-anti)-8-(2-cyclopropylmethoxy-4-trifluoromethyl-phenoxy)-3-(6-trifluoromethyl-pyridazin-3-yl)-3-aza-bicyclo[3.2.1]octane (CAS 933798-27-7), (8-syn)-8-(2-cyclopropylmethoxy-4-trifluoromethyl-phenoxy)-3-(6-trifluoromethyl-pyridazin-3-yl)-3-aza-bicyclo[3.2.1]octane (known from WO 2007040280 A1, WO 2007/040282 A1) (CAS 934001-668), N-[3-chloro-1-(3-pyridinyl)-1H-pyrazol-4-yl]-N-ethyl-3-[(3,3,3-trifluoropropyl)thio]-propanamide (known from WO 2015/058021 A1, WO 2015/058028 A1) (CAS 1477919-27-9) and N-[4-(aminothioxomethyl)-2-methyl-6-[(methylamino)carbonyl]phenyl]-3-bromo-1-(3-chloro-2-pyridinyl)-1H-pyrazole-5-carboxamide (known from CN 103265527 A) (CAS 1452877-50-7), 5-(1,3-dioxan-2-yl)-4-[[4-(trifluoromethyl)phenyl]methoxy]-pyrimidine (known from WO 2013/115391 A1) (CAS 1449021-97-9), 3-(4-chloro-2,6-dimethylphenyl)-4-hydroxy-8-methoxy-1-methyl-1,8-diazaspiro[4.5]dec-3-en-2-one (known from WO 2010/066780 A1, WO 2011/151146 A1) (CAS 1229023-34-0), 3-(4-chloro-2,6-dimethylphenyl)-8-methoxy-1-methyl-1,8-diazaspiro[4.5]decane-2,4-dione (known from WO 2014/187846 A1) (CAS 1638765-58-8), 3-(4-chloro-2,6-dimethylphenyl)-8-methoxy-1-methyl-2-oxo-1,8-diazaspiro[4.5]dec-3-en-4-yl-carbonic acid ethyl ester (known from WO 2010/066780 A1, WO 2011151146 A1) (CAS 1229023-00-0), N-[1-[(6-chloro-3-pyridinyl) methy1]-2(1H)-pyridinylidene]-2,2,2-trifluoro-acetamide (known from DE 3639877 A1, WO 2012/029672 A1) (CAS 1363400-41-2), [N(E)]-N-[1-[(6-chloro-3-pyridinyl) methyl]-2(1H)-pyridinylidene]-2,2,2-trifluoro-acetamide, (known from WO 2016005276 A1) (CAS 1689566-03-7), [N(Z)]-N-[1-[(6-chloro-3-pyridinyl)methyl]-2(1H)-pyridinylidene]-2,2,2-trifluoro-acetamide, (CAS 1702305-40-5), 3-endo-3-[2-propoxy-4-(trifluoromethyl)phenoxy-9-[[5-(trifluoromethyl)-2-pyridinyl]oxy]-9-azabicyclo[3.3.1]nonane (known from WO 2011/105506 A1, WO 2016/133011 A1) (CAS 1332838-17-1).

In certain embodiments, the active agent is a fungicide, or an insecticide selected from those shown in Table 1.

TABLE 1

| | | Melting | Solubility | |
|---|---|---|---|---|
| | Density | Point | in Water | |
| A.I. | (g/mL) | (° C.) | (mg/L) | Class |
| Azoxystrobin | 1.34^{a} | 116^{a} | 6.01^{a} | Fungicide |
| Beta-Cyfluthrin | 1.35 | 93.5 | 0.0012 | Fungicide |
| Carbendazim | 1.45 | 305 | 8 | Fungicide |
| Carbendazim | 1.39^{a} | 190^{a} | 797^{a} | Fungicide |
| Cyproconazole | 1.31^{a} | 106^{a} | 140^{a} | Fungicide |
| Epoxiconazole | 1.42^{a} | 128^{a} | 577^{a} | Fungicide |
| Fenamidone | 1.29 | 136.8 | 7.8 | Fungicide |
| Fluazinam | 1.80^{a} | 115^{a} | 0.68^{a} | Fungicide |
| Fludioxinil | 1.54^{a} | 199.8 | 1.8 | Fungicide |
| Fluopyram | 1.53 | 117.5 | 16 | Fungicide |
| Fluoxastrobin | 1.42 | 105 | 2.29 | Fungicide |
| Fluquinconazole | 1.58 | 191 | 1.15 | Fungicide |
| Ipconazole | 1.2 | 86 | 9.344 | Fungicide |
| Iprodione | 1 | 134 | 6.8 | Fungicide |
| Isotianil | 1.56^{a} | 186^{a} | 0.5 | Fungicide |
| Metalaxyl | 1.2 | 72 | 8400 | Fungicide |
| Metalaxyl-M | 1.09^{a} | 67.4^{a} | 10168^{a} | Fungicide |
| Metominostrobin | 1.13^{a} | 88^{a} | 128^{a} | Fungicide |
| Pencycuron | 1.22 | 132 | 0.3 | Fungicide |
| Penflufen | 1.18^{a} | 111 | 10.9 | Fungicide |
| Picarbutrazox | 1.3^{b} | N.D. | N.D. | Fungicide |
| Picoxystrobin | 1.28^{a} | 89.2^{a} | 8.30^{a} | Fungicide |
| Procymidone | 1.43^{a} | 166^{a} | 4.49^{a} | Fungicide |
| Propiconazole | 1.39^{a} | 103^{a} | 109^{a} | Fungicide |
| Prothioconazole | 1.36 | 141.8 | 300 | Fungicide |
| Pyraclostrobin | 1.34^{a} | 64.5^{a} | 26.0^{a} | Fungicide |
| Tebuconazole | 1.25 | 105 | 36 | Fungicide |
| Triadimenol | 1.27 | 132.5 | 72 | Fungicide |
| Trifloxystrobin | 1.36 | 72.9 | 0.61 | Fungicide |
| Abamectin | 1.28^{a} | 227^{a} | 36.4^{a} | Insecticide |
| Chlorantraniliprole | 1.65^{a} | 230^{a} | 1.33^{a} | Insecticide |
| Clothianidin | 1.61 | 176.8 | 340 | Insecticide |
| Cyantraniliprole | 1.65^{a} | 232^{a} | 37.5^{a} | Insecticide |
| Ethiprole | 1.69 | 188^{a} | 31.7^{a} | Insecticide |
| Fipronil | 1.71 | 203 | 3.78 | Insecticide |
| Flubendiamide | 1.78^{a} | 219^{a} | 0.10^{a} | Insecticide |
| Flupyradifurone | 1.43 | 69 | 3200 | Insecticide |
| Imidacloprid | 1.54 | 144 | 610 | Insecticide |
| Methiocarb | 1.25 | 118.5 | 27 | Insecticide |
| Spinetoram | 1.18^{a} | 198^{a} | 162^{a} | Insecticide |
| Spinosad | 1.20^{a} | 198^{a} | 295^{a} | Insecticide |
| Sulfoxaflor | 1.34^{a} | 141^{a} | 3189^{a} | Insecticide |
| Tefluthrin | 1.48 | 44.6 | 0.016 | Insecticide |
| Thiacloprid | 1.46 | 134^{a} | 184 | Insecticide |
| Thiamethoxam | 1.76^{a} | 158^{a} | 1278^{a} | Insecticide |
| Thiodicarb | 1.47 | 172.6 | 22.2 | Insecticide |

N.D.: Not Determine;
^{a}Values from the Chemistry Dashboard of the US Environmental Protection Agency;
^{b}Values predicted with the ACD/Labs Percepta Platform - PhysChem Module.

In some embodiments, the agrochemical formulation is a seed treatment formulation.

In some embodiments, the active agent is an insecticide selected from the group of abamectin, chlorantraniliprole, clothianidin, cyantraniliprole, ethiprole, fipronil, flubendiamide, flupyradifurone, imidacloprid, methiocarb, spinetoram, spinosad, sulfoxaflor, tefluthrin, thiacloprid, thiamethoxam, thiodicarb, and a combination thereof. In embodiments, the active agent comprises clothianidin.

In some embodiments, the active agent is a fungicide selected from the group of azoxystrobin, betacyfluthrin, carbendazim, carbendazim, cyproconazole, epoxiconazole, fenamidone, fluazinam, fludioxinil, fluopyram, fluoxastrobin, fluquinconazole, ipconazole, iprodione, isotianil, mefentrifluconazole, metalaxyl, metalaxyl-M, metominos-trobin, pencycuron, penflufen, picarbutrazox, picoxystrobin, procymidone, propiconazole, prothioconazole, pyraclostrobin, tebuconazole, triadimenol, trifloxystrobin, and a combination thereof. In one embodiment, the active agent is fluopyram. In another embodiment, the active agent is a triazole fungicide or a strobilurin fungicide.

In some embodiments, the active agent has a melting point above about 35° C., above about 40° C., above about 45° C., above about 50° C., above about 55° C., above about 60° C., above about 65° C., above about 70° C., above about 75° C., above about 80° C., above about 85° C., above about 90° C., above about 95° C., or above about 100° C. In other embodiments, the active agent has a melting point above about 100° C., above about 125° C., or above about 150° C.

### Surfactants

In general, the surfactant can be any surfactant that can wet and/or stabilize solid particles of the agrochemical active agents in a suspended form in an aqueous formulation. In general, the surfactant is provided as an aqueous solution comprising the surfactant and water. In some embodiments, the surfactant is a nonionic surfactant, a cationic surfactant, an anionic surfactant, or an amphoteric surfactant. In some embodiments, the surfactant comprises a nonionic surfactant, and anionic surfactant, or a combination thereof. In some embodiments, the surfactant is a nonionic surfactant.

Suitable nonionic surfactants include but are not limited to alkoxylates, N-substituted fatty acid amides, amine oxides, esters, sugar-based surfactants, polymeric surfactants, and mixtures thereof. In embodiments, the nonionic surfactant can include an alkoxylate surfactant, a polymeric surfactant, or a combination thereof.

Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. In embodiments, the alkoxylate surfactant can be an alcohol, an alkylphenol, an amine, an amide, an arylphenol, a fatty acid or fatty ester, or a combination of the foregoing, wherein the alkoxylate surfactant has been alkoxylated with 1 to 50 equivalents.

Examples of esters are fatty acid esters, glycerol esters or monoglycerides. Examples of polymeric surfactants also include homo- or copolymers of vinylpyrrolidone, vinylalcohols, or vinylacetate. Suitable block polymers are block polymers of the A-B or A-B-A type comprising blocks of polyethylene oxide and polypropylene oxide, or of the A-B-C type comprising alkanol, polyethylene oxide and polypropylene oxide. Examples of sugar-based surfactants are sorbitans, ethoxylated sorbitans, sucrose and glucose esters or alkylpolyglucosides. In embodiments, the polymeric surfactant can be a block polymer of the A-B or A-B-A type comprising blocks of polyethylene oxide and polypropylene oxide, a block polymer of the A-B-C type comprising alkanol, polyethylene oxide, and polypropylene oxide, a comb polymer, or a combination of the foregoing. In embodiments, the polymeric surfactant can be a block polymer of the A-B or A-B-A type comprising blocks of polyethylene oxide and polypropylene oxide, a block polymer of the A-B-C type comprising alkanol, polyethylene oxide, and polypropylene oxide, or a combination of the foregoing.

In one embodiment, the polymeric surfactant is a poloxamer. As used herein, a “poloxamer” is nonionic triblock copolymer composed of a central hydrophobic chain of polyoxypropylene (poly(propylene oxide)) flanked by two hydrophilic chains of polyoxyethylene (poly(ethylene oxide)). The poloxamer may be any one of Poloxamer 101, Poloxamer 105, Poloxamer 108, Poloxamer 122, Poloxamer 123, Poloxamer 124, Poloxamer 181, Poloxamer 182, Poloxamer 183, Poloxamer 184, Poloxamer 185, Poloxamer 188, Poloxamer 212, Poloxamer 215, Poloxamer 217, Poloxamer 231, Poloxamer 234, Poloxamer 235, Poloxamer 237, Poloxamer 238, Poloxamer 282, Poloxamer 284, Poloxamer 288, Poloxamer 331, Poloxamer 333, Poloxamer 334, Poloxamer 335, Poloxamer 338, Poloxamer 401, Poloxamer 402, Poloxamer 403, Poloxamer 407, Poloxamer 105 Benzoate, and Poloxamer 182 Dibenzoate.

In another embodiment, the polymeric surfactant is an acrylic copolymer solution. In one embodiment, the acrylic copolymer solution is a polymethyl methacrylate-polyethylene glycol graft copolymer. In some embodiments, the polymeric surfactant comprises a poloxamer, an acrylic copolymer, or a combination thereof.

Suitable cationic surfactants include but are not limited to quaternary surfactants, for example quaternary ammonium compounds with one or two hydrophobic groups, or salts of long-chain primary amines.

Suitable anionic surfactants include but are not limited to alkali, alkaline earth or ammonium salts of sulfonates, sulfates, phosphates, carboxylates, and mixtures thereof. In embodiments, the anionic surfactant comprises a sulfonate, a carboxylate, or a combination thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecyl-benzenes, sulfonates of naphthalenes and alkylnaphthalenes, sulfosuc-cinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

In one embodiment, the sulfonate is a sulfonate of condensed naphthalenes or a salt thereof. In another aspect, the sulfonate is naphthalene sulfonate condensate (NSC) or a salt thereof. In embodiments, the sulfonate includes a lignin sulfonate, a sulfonate of condensed napthalenes, a salt of the forgoing, or a combination of the foregoing. In embodiments, the carboxylate comprises an alkyl carboxylate, an alkylphenol ethoxylate, a polycarboxylic acid, a carboxylated alcohol, or a combination thereof.

Suitable amphoteric surfactants include but are not limited to alkylbetains and imidazolines. Suitable polyelectrolytes are polyacids or polybases. Examples of polyacids are alkali salts of poly-acrylic acid or polyacid comb polymers. Examples of poly-bases are polyvinylamines or polyethyleneamines.

In some embodiments, the surfactant can be a nonionic surfactant or an anionic surfactant. In one aspect, the nonionic surfactant is an alkoxylate surfactant or a polymeric surfactant. In one embodiment, the alkoxylate surfactant is an alcohol, alkylphenol, amine, amide, arylphenol, fatty acid or fatty acid ester; and the alkoxylate surfactant has been alkoxylated with 1 to 50 equivalents. In another embodiment, the polymeric surfactant is a block polymer of the A-B or A-B-A type comprising blocks of polyethylene oxide and polypropylene oxide or of the A-B-C type comprising alkanol, polyethylene oxide and polypropylene oxide.

In some embodiments, the polymeric surfactant is a poloxamer or an acrylic copolymer. In yet other aspects, the anionic surfactant is a sulfonate or a carboxylate. In one embodiment, the sulfonate is a lignin sulfonate, a sulfonate of condensed naphthalenes, or a salt thereof. In another embodiment, the carboxylate is an alkyl carboxylate, an alkylphenol ethoxylate, a polycarboxylic acid, or a carboxylated alcohol.

### Thickening/Structuring Agents

The formulations of the disclosure can also include a thickening and/or structuring agent. As used herein and unless specified otherwise, the terms thickening agent and structuring agent are used interchangeably. The thickening and/or structuring agent can generally be any compound that can prevent or reduce the separation of the solid particles of the agrochemical active agent from the aqueous formulation over an extended period of time under typical storage conditions and/or a compound that can prevent or reduce the formation of a hard packed sediment of the particles of the agrochemical active agent upon storage of the formulations of the disclosure over an extended period of time under typical storage conditions.

Thickening and/or structuring agents can include polysaccharides, clays, celluloses, polyacrylates, and silicas. Suitable thickening agents include, but are not limited to, starch, xanthan gum, guar gum, locust bean gum, gum karaya, gum tragacanth, gum Arabic, methyl cellulose, ethyl cellulose, methylhydroxyethyl cellulose, methylhydroxyethylhydroxypropyl cellulose, hydroxypropyl methyl cellulose, pectin, agar, alginin, carrageenan, pullulan, and alginic acid salts. In embodiments, the thickening and/or structuring agent can include a polysaccharide, a cellulose, or a combination thereof. In embodiments, the thickening agent can be a micro- and/or nano-crystalline cellulose. In embodiments, the thickening and/or structuring agent can include xanthan gum, methyl cellulose, ethyl cellulose, hydroxypropyl methyl cellulose, or a combination thereof. In embodiments, the thickening and/or structuring agent includes xanthan gum.

### Auxiliary Ingredients

Auxiliary ingredients can be included in the formulations of the disclosure. Auxiliary ingredients can include ingredients commonly used in agricultural treatment formulations and known to those of ordinary skill in the art. Examples include antioxidants such as ascorbic acid, penetrants, biocides, preservatives, deodorizers, fragrances, antifreezes and evaporation inhibitors such as glycerol and ethylene or propylene glycol, sorbitol, mineral oil, process oils, sodium lactate, fillers, extenders, carriers, colorants including pigments and/or dyes, pH modifiers (buffers, acids, and bases), salts such as calcium, magnesium, ammonium, potassium, sodium, and/or iron chlorides, fertilizers such as ammonium sulfate and ammonium nitrate, urea, and processing aids such as dispersing agents, emulsifiers, wetting agents, defoamers and suspension agents. The aqueous formulation may also contain other active ingredients such as additional fungicides, insecti-cides, pesticides, and/or fertilizers known in the art.

Suitable defoamers include all customary defoamers including silicone-based and those based upon perfluoroalkyl phosphinic and phosphonic acids, in particular silicone-based defoamers, such as silicone oils, for example. Defoamers most commonly used are those from the group of linear polydimethylsiloxanes having an average dynamic viscosity, measured at 25° C., in the range from 1000 to 8000 mPas (mPas—millipascal-second), usually 1200 to 6000 mPas, and containing silica. Silica includes polysilicic acids, meta-silicic acid, ortho-silicic acid, silica gel, silicic acid gels, kieselguhr, precipitated SiO₂, and the like.

Defoamers from the group of linear polydimethyl-siloxanes contain as their chemical backbone a compound of the formula HO—[Si(CH₃)₂—O—]ₙ—H, in which the end groups are modified, by etherification for example, or are attached to the groups —Si(CH₃)₃. Non-limiting examples of defoamers of this kind are RHODORSIL® Antifoam 416 (Rhodia) and RHODORSIL® Antifoam 481 (Rhodia). Other suitable defoamers are RHODORSIL® 1824, ANTI-MUSSOL 4459-2 (Clamant), Defoamer V 4459 (Clariant), SE Visk and AS EM SE 39 (Wacker). The silicone oils can also be used in the form of emulsions.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulphoxide, and also water.

All suitable carriers may be used. Suitable carriers are in particular: for example, ammonium salts and ground natural minerals such as kaolins, clays, talc, chalk, quartz, attapulgite, montmorillonite or diatomaceous earth, and ground synthetic minerals, such as finely divided silica, alumina and natural or synthetic silicates, resins, waxes and/or solid fertilizers. Mixtures of such carriers may likewise be used. Carriers suitable for granules include the following: for example, crushed and fractionated natural minerals such as calcite, marble, pumice, sepiolite, dolomite, and also synthetic granules of inorganic and organic meals, and also granules of organic material such as sawdust, paper, coconut shells, maize cobs and tobacco stalks.

Liquefied gaseous extenders or solvents may also be used. Particularly suitable are those extenders or carriers which at standard temperature and under standard pressure are gaseous, examples being aerosol propellants, such as halogenated hydrocarbons, and also butane, propane, nitrogen and carbon dioxide.

Examples of emulsifiers and/or foam-formers, dispersants or wetting agents having ionic or nonionic properties, or mixtures of these surface-active substances, are salts of polyacrylic acid, salts of lignosulphonic acid, salts of phenolsulphonic acid or naphthalenesulphonic acid, poly-condensates of ethylene oxide with fatty alcohols or with fatty acids or with fatty amines, with substituted phenols (preferably alkylphenols or arylphenols), salts of sulphosuccinic esters, taurine derivatives (preferably alkyltaurates), phosphoric esters of polyethoxylated alcohols or phenols, fatty acid esters of polyols, and derivatives of the compounds containing sulphates, sulphonates and phosphates, examples being alkylaryl polyglycol ethers, alkylsulphonates, alkyl sulphates, arylsulphonates, protein hydrolysates, lignin-sulphite waste liquors and methylcellulose. The presence of a surface-active substance is advantageous if one of the active compounds and/or one of the inert carriers is not soluble in water and if application takes place in water.

Further auxiliaries that may be present in the formulations and in the application forms derived from them include colorants such as inorganic pigments, examples being iron oxide, titanium oxide, Prussian Blue, and organic dyes, such as alizarin dyes, azo dyes and metal phthalocyanine dyes, and nutrients and trace nutrients, such as salts of iron, manganese, boron, copper, cobalt, molybdenum and zinc.

Stabilizers, such as low-temperature stabilizers, preservatives, antioxidants, light stabilizers or other agents which improve chemical and/or physical stability may also be present.

### Agrochemical Formulations

The agrochemical formulations of the disclosure generally include the agrochemical active agent dispersed in a mixture of water, the aqueous surfactant, and a thickening agent. Optionally, the agrochemical formulations can include any of the auxiliary ingredients disclosed herein.

The agrochemical formulations of the disclosure can generally include about 57 to about 76% (w/w) of at least one agrochemical active agent, based on the total weight of the formulation (i.e., based on the total weight of the dispersion). In embodiments, the agrochemical active agent can be provided in the formulation in an amount in a range of about 57% to about 76% (w/w), about 60% to about 75% (w/w), about 60% to about 70% (w/w), about 62% to about 70% (w/w), or about 65% to about 70% (w/w), based on the total weight of the formulation.

The agrochemical active agent can be selected from a combination of agrochemical active agents. As defined above, the agrochemical active agent can be any chemical or combination of chemicals useful in agriculture, including, but not limited to insecticides, herbicides, fungicides, algaecides, rodenticides, molluscicides, nematicides, fertilizers, soil conditioners, liming and acidifying agents, and plant growth regulators. In embodiments, the agrochemical active agent comprises an insecticide, an herbicide, a fungicide, an algaecide, a rodenticide, a molluscicide, a nematicide, or a combination thereof. In embodiments, the agrochemical active agent comprises an insecticide, an herbicide, a fungicide, or a combination thereof. In embodiments, the agrochemical active agent comprises an insecticide, a fungicide, or a combination thereof.

In addition or in the alternative, the agrochemical formulation can be characterized by the concentration of agrochemical active agent in the agrochemical formulation. In general, the concentration of the agrochemical active agent in the agrochemical formulation is at least 750 g/L. In embodiments, the concentration of the agrochemical active agent in the agrochemical formulation is in a range of about 750 g/L to about 1000 g/L, about 800 g/L to about 950 g/L, about 800 g/L to about 900 g/L, or about 825 g/L to about 875 g/L. Advantageously, the methods of the disclosure can provide ultra-high load agricultural formulations including at least about 750 g/L of agricultural active agents, wherein the active agents remain dispersed in an aqueous composition, with minimal or no settling or agglomeration of the active agents.

Surfactant can be provided in the agrochemical formulations of the disclosure in an amount in a range of about 0.1% to about 10% (w/w), based on the total weight of the agrochemical formulation, for example, about 0.5% to about 10% (w/w), about 1% to about 9% (w/w), about 2% to about 8% (w/w), about 2% to about 6% (w/w), or about 4% to about 6% (w/w) based on the total weight of the agrochemical formulation.

Thickening and/or structural agents can be provided in the formulations of the disclosure in an amount in a range of about 0.01% to about 3% (w/w), based on the total weight of the agrochemical formulation, for example, about 0.01% to about 2% (w/w), about 0.01% to about 1% (w/w), about 0.01% to about 0.50% (w/w), about 0.01% to about 0.20% (w/w), or about 0.05% to about 0.15% (w/w), based on the total weight of the agrochemical formulation.

The balance of the agrochemical formulations of the disclosure comprises any optional auxiliary ingredients and water. Water can be provided in the agrochemical formulations of the disclosure in an amount in a range of about 10% to about 40% (w/w), based on the total weight of the agrochemical formulation, for example, about 15% to about 35% (w/w), about 20% to about 35% (w/w), about 20% to about 30% (w/w), or about 25% to about 30% (w/w), based on the total weight of the agrochemical formulation.

Immediately upon preparation of the agrochemical formulation, the agrochemical formulation is in the form of a flowable fluid. Advantageously, when the formulation is allowed to sit unperturbed, the agrochemical formulation forms a shear thinning gel. Without intending to be bound by theory, it is believed that the gel form of the formulation allows the agrochemical active agents to remain stable towards settling, phase separation, and/or agglomeration (i.e., inhibits settling and/or agglomeration of the active agent) during storage and before use by an end user. Further, the gel formulation is advantageously shear thinning, which allows the gel to transform back into a flowable fluid with moderate agitation.

In embodiments, the agrochemical formulation in the form of a shear thinning gel has a viscosity of greater than about 1000 cP, greater than about 1500 cP, or greater than 2000 cP. In general, upon agitation, the viscosity of the agrochemical formulation decreases. In embodiments, upon agitation the viscosity of the agrochemical formulation decreases such that the agrochemical formulation becomes a flowable fluid. In embodiments, the gelled agrochemical formulation can be agitated to provide a flowable fluid having a viscosity in a range of about 200 cP to about 1000 cP, about 300 cP to about 900 cP, or about 400 cP to about 800 cP. The gelled agrochemical formulation can be agitated under any conditions sufficient to decrease the viscosity of the gelled agrochemical formulation. The means for agitating the gelled agrochemical formulation to form a flowable fluid are not particularly limited. For example, a container including a gelled agrochemical formulation can be shaken, or a gelled agrochemical formulation can be mechanically agitated in a container using, for example, a mixing blade. Suitable mixing blades can include, but are not limited to, impellers such as turbines, propellers, hydrofoils, paddles, and dispersion blades. Conditions sufficient for decreasing the viscosity of the gelled agrochemical formulation can include operating the agitator means at a rate of at least 50 rotation per minute (rpm), at least 75 rpm, at least 100 rpm, at least about 500 rpm, at least about 750 rpm, at least about 1000 rpm, and up to about 500 rpm, up to about 750 rpm, up to about 1000 rpm, up to about 1500 rpm, or up to about 2000 rpm, for example, in a range of about 50 rpm to about 2000 rpm or about 50 rpm to about 1000 rpm. The person of ordinary skill in the art will readily appreciate that as the rate of the agitator means is increased, the amount of time required to decrease a gelled agrochemical formulation from a first viscosity to a second viscosity will decrease. Accordingly, the rate of agitation and the time of agitation can be selected based on energy and time available to an end user.

### Methods of Preparing Agrochemical Formulations

The disclosure further provides methods of forming agrochemical formulations, the methods including the steps of
(a) homogenizing a first mixture comprising at least one agrochemical active agent in water to form a first homogenized mixture;
(b) forming a first mill base by:
   (i) bead milling the first homogenized mixture to form first particles having a D90 particle size of about 1-75 microns; or
   (ii) colloid milling the first homogenized mixture to form first particles having a D50 particles size of about 1-75 microns;
(c) homogenizing a second mixture comprising at least one agrochemical active agent and the first mill base to form a second homogenized mixture;
(d) bead milling the second homogenized mixture to form a second mill base including second particles having a D90 particles size of about 1-75 microns;
(e) homogenizing a third mixture comprising an aqueous surfactant solution and a thickening agent to form a slurry; and
(f) combining the slurry with the second mill base to form an agrochemical formulation comprising 57-76% (w/w) of the agrochemical active agent, based on the total weight of the formulation, thereby forming the agrochemical formulation;
   wherein, the first mixture comprises 20-70% (w/w) of the at least one agrochemical active agent with the balance including water and optionally a surfactant, an antifreeze, a biocide, an antifoaming agent, or a combination thereof; and the second mixture comprises 10-50% (w/w) of the at least one agrochemical active agent, based on the total weight of the second mixture.

As used herein and unless defined otherwise, the terms “homogeneous,” “homogenizing,” and other iterations thereof are used in accordance with the ordinary meaning of homogenous. In the specific context of a mixture of an agrochemical active agent in water, “homogenous” and other iterations thereof refer to a dispersion of the agrochemical active agent in water, wherein the agrochemical active agent is substantially uniformly distributed throughout the mixture.

Methods of homogenizing mixtures are generally known in the art. For example, the first mixture can be homogenized by overhead mixing, impeller mixing, magnetic stirring, or a combination thereof. In embodiments, the first mixture can be homogenized using an overhead mixer. In embodiments, the first mixture can be homogenized using magnetic stirring.

The agrochemical active agent in the first mixture can include any agrochemical active agent disclosed herein. The amount of agrochemical active agent provided by the first mixture can be in a range of about 20% to about 70% (w/w) based on the total weight of the first mixture, for example, in a range of about 25% to about 65% (w/w), about 30% to about 60% (w/w), about 35% to about 55% (w/w), about 40% to about 50% (w/w), or about 45% to about 55% (w/w). The amount of agrochemical active agent provided in the first mixture can also be characterized by the amount of agrochemical active agent in the first mixture, relative to the total amount of agrochemical active agent provided in the final composition. The amount of agrochemical active agent provided by the first mixture can be in a range of about 30% to about 75% (w/w), based on the total amount of agrochemical active agent in the final agrochemical formulation, for example, about 30% to about 70%, about 35% to about 60% (w/w), about 35% to about 55%, or about 40% to about 50% (w/w), or about 75% (w/w) or less, about 70% (w/w) or less, about 65% (w/w) or less, about 50% (w/w) or less, about 48% (w/w) or less, about 46% (w/w) or less, or about 44% (w/w) or less, based on the total amount of agrochemical active agent in the final agrochemical formulation, with the balance of the agrochemical active agent being supplied in the second mixture of the agrochemical active agent in the second mixture. The first mixture and first homogenized mixture can further include any surfactants and/or any auxiliary ingredients disclosed herein. In embodiments, the first mixture further comprises a surfactant. In embodiments, the first mixture further comprises a surfactant and one or more of an antifreeze, a biocide, and an antifoaming agent. The agrochemical active agent and any surfactants and/or any auxiliary ingredients can be combined to form the first mixture in any order.

When included in the first mixture and first homogenized mixture, the surfactant can be included in an amount in a range of about 0.1% to about 15% (w/w) based on the total weight of the first mixture, for example, about 0.5% to about 12% (w/w), about 1% to about 10% (w/w), about 2% to about 10% (w/w), about 3% to about 8% (w/w), about 4% to about 8% (w/w), about 5% to about 8% (w/w), about 6% to about 8% (w/w), or about 3%, about 4%, about 5%, about 6%, about 7%, about 8%, about 9%, about 10%, about 11%, about 12%, about 13%, about 14%, or about 15% (w/w), based on the total weight of the first mixture. When included in the first mixture and first homogenized mixture, auxiliary ingredients can be included in a total amount in a range of about 0.1% to about 10% (w/w), based on the total weight of the first mixture, for example, in a range of about 0.5% to about 8% (w/w), about 1% to about 6% (w/w), about 2% to about 5% (w/w), about 3% to about 5% (w/w), or about 3.5% to about 4.5% (w/w), based on the total weight of the first mixture.

The first mixture and the first homogenized mixture further comprise water. Water can generally be provided in any amount suitable to arrive at a final agrochemical formulation having an amount of agrochemical active agent in a range of about 57% to about 76% (w/w) based on the total weight of the formulation. In embodiments, the first mixture and first homogenized mixture can include water in an amount in a range of about 7% to about 80% (w/w) based on the total weight of the first mixture, for example, about 10% to about 70% (w/w), about 20% to about 60% (w/w), about 30% to about 50% (w/w), about 35% to about 45% (w/w), or about 40% (w/w), based on the total weight of the first mixture.

The first homogenized mixture can be milled to form a first mill base including first particles of agrochemical active agent having reduced particle size, relative to the raw agrochemical active agent material. Various techniques can be used to perform the milling including those explained in Nakach et al., Journal of Pharmaceutical Sciences 106 (2017) 1889-1904 and in Loh et al., Asian Journal of Pharmaceutical Sciences 10 (2015) 255-274, the entirety of which are hereby incorporated by reference. The milling of the first homogenized mixture can be carried out with a bead mill or a colloid mill. In one embodiment, the equipment used to carry out the milling is a bead mill. In another embodiment, the equipment used to carry out the milling is a colloid mill. The mills used to perform the methods disclosed herein may be horizontal or vertical.

In embodiments, the milling of the first homogenized mixture is carried out with a bead mill until the D90 particle size of the first particles of agrochemical active agent is about 1 micron to about 75 microns, for example, in a range of about 1 micron to about 70 microns, about 1 micron to about 65 microns, about 1 micron to about 60 microns, about 1 micron to about 55 microns, about 1 micron to about 50 microns, about 1 micron to about 45 microns, about 1 micron to about 40 microns, about 1 micron to about 35 microns, about 1 micron to about 30 microns, about 1 micron to about 25 microns, about 1 micron to about 20 microns, about 1 micron to about 20 microns, about 1 micron to about 15 microns, about 1 micron to about 10 microns, about 1 micron to about 5 microns, about 3 microns to about 20 microns, about 3 microns to about 15 microns, about 3 microns to about 10 microns, about 3 microns to about 8 microns, or about 4 microns to about 6 microns. In embodiments, the milling is continued until the D90 particle size of the first particles is between about 3 microns and about 8 microns. In embodiments, the milling is continued until the D90 particle size of the first particles is about 4 microns to about 6 microns.

In embodiments, the milling of the first homogenized mixture is carried out with a colloid mill until the D50 particle size of the first particles of agrochemical active agent is about 1 micron to about 75 microns, for example, about 1 micron to about 70 microns, about 5 microns to about 70 microns, about 10 microns to about 70 microns, about 15 microns to about 70 microns, about 20 microns to about 70 microns, about 25 microns to about 70 microns, about 30 microns to about 70 microns, about 35 microns to about 65 microns, about 40 microns to about 60 microns, about 45 microns to about 55 microns, or about 50 microns. In embodiments, the milling is continued until the D50 particle size of the first particles is between about 45 microns to about 55 microns. In embodiments, the milling is continued until the D50 particle size of the first particles is between about 48 microns and 52 microns.

The particles size may be measured by any method known in the art such as laser diffraction, FBRM (focused beam reflectance measurement), UAS (ultrasonic attenuation spectroscopy), PDA (phase Doppler method), SFT (spatial filtering technique), or SDV (shadow Doppler velocimetry).

The second mixture can be homogenized using any method known in the art. For example, the second mixture can be homogenized by overhead mixing, impeller mixing, magnetic stirring, or a combination thereof. In embodiments, the second mixture can be homogenized using an overhead mixer. In embodiments, the second mixture can be homogenized using magnetic stirring.

The agrochemical active agent in the second mixture can include any agrochemical active agent disclosed herein. In embodiments, the agrochemical active agent in the second mixture is the same active agent as in the first mixture. In embodiments, the agrochemical active agent in the second mixture is a different active agent from the first mixture. In embodiments, the agrochemical active agent in the second mixture comprises the same active agent as in the first mixture and a different active agent as in the first mixture. The amount of agrochemical active agent in the second mixture can be in a range of about 20% to about 70% (w/w) based on the total weight of the second mixture, for example, in a range of about 25% to about 65% (w/w), about 20% to about 60% (w/w), about 25% to about 55% (w/w), about 30% to about 50% (w/w), or about 35% to about 45% (w/w). The amount of agrochemical active agent in the second mixture can also be characterized by the amount of agrochemical active agent in the second mixture, relative to the total amount of agrochemical active agent provided in the final composition. The amount of agrochemical active agent in the second mixture can be in a range of about 25% to about 70% (w/w), based on the total amount of agrochemical active agent in the final agrochemical formulation, for example, about 30% to about 70%, about 40% to about 65%, about 45% to about 65%, or about 50% to about 60%, for example about 50% (w/w) or more about 52% (w/w) or more, about 54% (w/w) or more, or about 56% (w/w) or more, based on the total amount of agrochemical active agent in the final agrochemical formulation, with the balance of the agrochemical active agent being supplied in the first in the first mixture. The balance of the second mixture and second homogenized mixture is comprised of the first mill base and optionally, a surfactant or other auxiliary agent. In embodiments, the second mixture further consists essentially of the of the agrochemical active agent and the first mill base. In embodiments, the second mixture further comprises one or more of an antifreeze, a biocide, and an antifoaming agent.

The second homogenized mixture can be milled to reduce the particle size of the agrochemical active agent and form a second mill base including second particles. Various techniques can be used to perform the milling including those explained in Nakach et al., Journal of Pharmaceutical Sciences 106 (2017) 1889-1904 and in Loh et al., Asian Journal of Pharmaceutical Sciences 10 (2015) 255-274, the entirety of which are hereby incorporated by reference. The milling of the second homogenized mixture can be carried out with a bead mill or a colloid mill. In one embodiment, the equipment used to carry out the milling is an annular gap bead mill.

In embodiments, the milling of the second homogenized mixture is carried out with a bead mill until the D90 particle size of the second particles of agrochemical active agent is about 1 micron to about 75 microns, for example, in a range of about 1 micron to about 70 microns, about 1 micron to about 65 microns, about 1 micron to about 60 microns, about 1 micron to about 55 microns, about 1 micron to about 50 microns, about 1 micron to about 45 microns, about 1 micron to about 40 microns, about 1 micron to about 35 microns, about 1 micron to about 30 microns, about 1 micron to about 25 microns, about 1 micron to about 20 microns, about 1 micron to about 20 microns, about 1 micron to about 15 microns, about 1 micron to about 10 microns, about 1 micron to about 5 microns, about 3 microns to about 20 microns, about 3 microns to about 15 microns, about 3 microns to about 10 microns, about 3 microns to about 8 microns, or about 4 microns to about 6 microns. In embodiments, the milling is continued until the D90 particle size of the second particles is between about 3 microns and about 8 microns. In embodiments, the milling is continued until the D90 particle size of the second particles is about 4 microns to about 6 microns.

In some embodiments, the first mixture and/or second mixture are substantially free of a surfactant. As used herein and unless defined otherwise, “substantially free of a surfactant” means that the mixture includes less than about 1 wt % of a surfactant, based on the total weight of the mixture, for examples, less than about 0.5 wt %, less than 0.1 wt %, or less than 0.01 wt. %. In some embodiments, the first mixture includes surfactant and the second mixture is substantially free of surfactant. In some embodiments, the first mixture and the second mixture are substantially free of surfactant.

In embodiments wherein the milling of the first homogenized mixture is carried out with a bead mill, the bead milling can be carried out under any conditions sufficient to reduce the particle size of the agrochemical active agent, without decomposing the active agent. In general, the bead milling is carried out under wet conditions. In embodiments, the bead milling uses glass beads at a 60-90% load, for example, at a 70-85% load or a 75-80% load. In embodiments, the bead milling uses glass beads at a 75-80% load. In general, as the loading of beads decreases, the amount of grinding achieved can decrease and/or the time for grinding can increase beyond an acceptable time limit. As the loading of beads increases the likeliness of heat generation increases which can result in the mixture becoming thick and unprocessable. In embodiments, the glass beads for milling have a diameter of about 0.50 mm to about 1.25 mm, for example, in a range of about 0.60 mm to about 1.15 mm, about 0.65 mm to about 1.10 mm, about 0.70 mm to about 1.05 mm, or about 0.75 mm to about 1.00 mm. In embodiments, the glass beads have a diameter of about 0.75 mm to about 1.00 mm. In general, as the size of the beads increase, the amount of grinding achieved can decrease and/or the time for grinding can increase beyond an acceptable time limit. As the size of the beads decrease, enhanced grinding can be achieved, however the likeliness of heat generation increases which can result in the mixture becoming thick and unprocessable. In embodiments, the bead mill can be operated at about 1500 rpm to about 3500 rpm, for example, about 2000 rpm to about 3000 rpm, or about 2250 rpm to about 2750 rpm, or about 2500 rpm. In embodiments, the bead mill is operated at about 2250 rpm to about 2750 rpm. In general, as the rotational speed decreases, process time increases, and particle size reduction can be limited. As the rotational speed increases, the likelihood of heat generation increases which can result in the mixture becoming thick and unprocessable.

In embodiments wherein the milling of the first homogenized mixture is carried out with a colloid mill, the colloid milling can be carried out under any conditions sufficient to reduce the particle size of the agrochemical active agent, without decomposing the active agent. In embodiments, the colloid mill can be operated at a gap width in a range of about 0.6 mm to about 0.16 mm gap, for example about 0.5 mm to about 0.16 mm, about 0.4 mm to about 0.16 mm, about 0.3 mm to about 0.16 mm, or about 0.2 mm to about 0.16 mm. In embodiments, the colloid mill can be operated at a gap width of about 0.16 mm. In embodiments, the colloid mill can be operated at a rotational speed in a range of about 1000 rpm to about 20,000 rpm, for example, about 2000 rpm to about 18,000 rpm, about 2000 rpm to about 16,000 rpm, about 2000 rpm to about 14,000 rpm, about 2000 rpm to about 12,000 rpm, about 4000 rpm to about 10,000 rpm, about 6000 rpm to about 10,000 rpm, about 7000 rpm to about 9000 rpm, or about 7500 rpm to about 8500 rpm, or about 6000 rpm, about 8000 rpm, about 10,000 rpm, about 15,000 rpm, or about 20,000 rpm. In embodiments, the colloid mill can be operated at a rotational speed in a range of about 6000 rpm to about 10,000 rpm. In embodiments, the colloid mill can be operated at a rotational speed in a range of about 7000 rpm to about 9000 rpm.

In embodiments wherein the milling of the second homogenized mixture is carried out with a bead mill, the bead milling can be carried out under any conditions sufficient to reduce the particle size of the agrochemical active agent, without decomposing the active agent. In general, the bead milling is carried out under wet conditions. In embodiments, the bead milling of the second homogenized mixture uses glass beads at a 25-70% load, for example, at a 30-60% load, a 30-50% load, a 40-50% load, or about a 45% load. In embodiments, the bead milling of the second homogenized mixture uses glass beads at a 40-50% load. In embodiments, the glass beads for milling have a diameter of about 0.50 mm to about 1.25 mm, for example, in a range of about 0.60 mm to about 1.15 mm, about 0.65 mm to about 1.10 mm, about 0.70 mm to about 1.05 mm, or about 0.75 mm to about 1.00 mm. In embodiments, the glass beads have a diameter of about 0.75 mm to about 1.00 mm. In embodiments, the bead mill can be operated at about 1500 rpm to about 3500 rpm, for example, about 2000 rpm to about 3000 rpm, or about 2250 rpm to about 2750 rpm, or about 2500 rpm. In embodiments, the bead mill is operated at about 2250 rpm to about 2750 rpm.

In general, the temperature of the milling steps can be any suitable temperature. As the temperature increases, the likeliness of gelling increases, the likeliness of degradation of the active increases, and the likeliness of a spike in heat or exotherm increases. Accordingly, in embodiments, the milling steps can occur in a mill with a controlled temperature set between about 1° C. and about 60° C., for example, between about 1° C. and about 55° C., between about 1° C. and about 50° C., between about 1° C. and about 45° C., between about 1° C. and about 40° C., between about 1° C. and about 35° C., between about 1° C. and about 30° C., between about 1° C. and about 25° C., or between about 1° C. and about 20° C. In yet other embodiments, the milling occurs in a mill with a controlled temperature set between about 5° C. and about 60° C., between about 5° C. and about 55° C., between about 5° C. and about 50° C., between about 5° C. and about 45° C., between about 5° C. and about 40° C., between about 5° C. and about 35° C., between about 5° C. and about 30° C., between about 5° C. and about 25° C., or between about 5° C. and about 20° C. In embodiments, the milling occurs in a mill with a controlled temperature set between about 1° C. and about 40° C.

The third mixture can be homogenized using any method known in the art. For example, the third mixture can be homogenized by overhead mixing, impeller mixing, magnetic stirring, or a combination thereof. In embodiments, the third mixture can be homogenized using an overhead mixer. In embodiments, the third mixture can be homogenized using magnetic stirring.

The third mixture generally includes an aqueous surfactant solution, including a surfactant and water, and a thickening agent. After homogenizing the third mixture, a slurry is formed with the thickening agent dispersed in the surfactant solution. The third mixture can include any surfactant disclosed herein and any thickening agent disclosed herein. The surfactant can be provided in an amount in a range of about 5% to about 15% (w/w) based on the total weight of the third mixture, for example, about 6% to about 14% (w/w), about 7% to about 13% (w/w), about 8% to about 12% (w/w), about 9% to about 11% (w/w), or about 10% (w/w), based on the total weight of the third mixture. The thickening agent can be provided in an amount in a range of about 0.01% to about 5% (w/w) based on the total weight of the third mixture, for example, about 0.5% to about 4.5% (w/w), about 1.0% to about 4.0% (w/w), about 1.5% to about 3.5% (w/w), or about 2.0% to about 3.0% (w/w) based on the total weight of the third mixture. The balance of the third mixture can be water, antifreeze, glycerin, propylene glycol, or a combination thereof, provided in an amount in a range of about 81% to about 95% (w/w) based on the total weight of the third mixture, for example, about 83% to about 92% (w/w), or about 85% to about 90% (w/w) based on the total weight of the third mixture. In embodiments, the balance of the third mixture is water. In embodiments, the balance of the third mixture is glycerin.

The slurry prepared from the third mixture is combined with the second mill base to form the agrochemical formulation comprising about 57% to about 76% of the agrochemical active agent, based on the total weight of the agrochemical formulations. The method for combining the third mixture with the second mill base is not particularly limited and can include simply admixing the two compositions at ambient temperature and relative humidity. Upon combining of the third mixture and the second mill base, the combination can be stirred under moderate conditions, for example, about 200-1500 rpm, for up to about an hour, for example, about 30 to about 60 minutes.

The agrochemical formulations resulting from the methods disclosed herein are described in detail, supra. As disclosed herein, the agrochemical formulations can advantageously include at least about 57 to about 76% (w/w) of an agrochemical active agent, based on the total weight of the formulation, or at a concentration of at least 750 g/L. Advantageously, upon formation of the agrochemical formulation, when the formulation is left undisturbed at ambient conditions the formulation forms a reversible gel which inhibits the settling and/or agglomerating of the agrochemical active agent particles. The reversible gel network possesses a storage modulus (G′) of greater than 250 Pa measured after a 48 hr equilibration time. Oscillatory measurements for G′ are carried out in the linear viscoelastic region at a fixed frequency of 0.5 Hz.

The reversible gel can form a flowable fluid upon agitation and reform into gel upon storing undisturbed. Advantageously, the gel form of the agrochemical formulation can be stored for at least 1 month, at least 2 months, at least 3 months, at least 4 months, at least 6 months, or at least 12 months, without significant settling, agglomeration, and/or syneresis of the gel components. As used herein, and unless defined otherwise, a “significant” settling, agglomeration, and/or syneresis refers to 15% or more of the solid, agrochemical active agent sedimenting out of the gel and/or 15% or more of the liquid separates from the gel. In embodiments, the agrochemical formulations of the disclosure demonstrate about 12% or less, about 10% or less, or about 8% or less of settling, agglomeration and/or syneresis.

### Articles and Methods for Using the Agrochemical Formulation of the Disclosure

Further provided herein is an article for dispensing an agrochemical formulation of the disclosure comprising a container fitted with a mixing blade and the agrochemical formulation of the disclosure provided in the container and in contact with the mixing blade, wherein the mixing blade is configured to facilitate a phase transition of the agrochemical formulation from a gel to a flowable fluid.

In general, the container can be any container suitable for holding the agrochemical formulation in the form of a gel and in the form of a flowable fluid. The container can include a lid portion such that the container can fully encompass the agrochemical formulation. The container can also include a means for dispensing the agrochemical formulation from the container. The means for dispensing the agrochemical formulation can enable pouring, spraying, or otherwise dispensing of the agrochemical formulation from the container. The means for dispensing the agrochemical formulation can include, but are not limited to, valves, hoses, and nozzles. In some embodiments, a substrate to be treated by the agrochemical formulation can be added to the container and mixed with the agrochemical formulation using the mixing blade.

The mixing blade is generally configured to facilitate a phase transition of the agrochemical formulation from a gel to a flowable fluid. The mixing blade mechanically agitates the agrochemical formulation in the form of a gel inside the container. Suitable mixing blades can include, but are not limited to, impellers such as turbines, propellers, hydrofoils, paddles, and dispersion blades. The mixing blade can be operatively associated with a controller, such as a mechanical switch or electrical controller, to control the mixing blade and the rate at which the mixing blade is operated. Without intending to be bound by theory, it is believed that only moderate agitation is needed to facilitate a phase transition of the agrochemical formulation gel into a flowable fluid. As used herein, “moderate agitation” can be achieved by operating the mixing blade at a rate of at least 60 rotation per minute (rpm), for example, at least 75 rpm, or at least 100 rpm.

Further provided herein are kits comprising a container fitted with a mixing blade and the agrochemical formulation of the disclosure. The container can be any container disclosed herein and the mixing blade can be any mixing blade disclosed herein. The agrochemical formulation can be provided in the container or can be provided in a separate vessel and transferred into the container at the point of use. The mixing blade can be configured to facilitate a phase transition of the agrochemical formulation from a gel to a flowable fluid.

Further provided herein are methods of treating a substrate with an agrochemical formulation of the disclosure, comprising providing an agrochemical formulation of the disclosure and applying the flowable fluid to the substrate. Optionally, the agrochemical formulation of the disclosure can be provided in the gel form and agitated to facilitate the phase transition to the flowable fluid prior to applying the flowable agrochemical formulation to the substrate.

In embodiments, the substrate to be treated can be propagation material of plants, including but not limited to, cuttings, callus cultures, rhizomes or tubers, fruits, seeds, seedlings, protplasts, cell cultures, and the like.

In some embodiments, the agrochemical formulation is a seed treatment formulation. These formulations may be used to protect seeds from unwanted microorganisms, such as phytopathogenic microorganisms, for instance phytopathogenic fungi or phytopathogenic oomycetes. The term seed(s) as used herein include dormant seeds, primed seeds, pregerminated seeds and seeds with emerged roots and leaves.

Thus, the disclosure also relates to a method for protecting seeds from unwanted microorganisms which comprises the step of treating the seeds with the formulations of the disclosure.

The treatment of seeds with the formulations of the disclosure can protect the seeds from phytopathogenic microorganisms, but also protects the germinating seeds, the emerging seedlings and the plants after emergence from the treated seeds. Therefore, the disclosure also relates to a method for protecting seeds, germinating seeds and emerging seedlings. The seeds treatment may be performed prior to sowing, at the time of sowing or shortly thereafter.

When the seeds treatment is performed prior to sowing (e.g., so-called on-seed applications), the seeds treatment may be performed as follows: the seeds may be placed into a mixer with a desired amount of the formulations of the disclosure, the seeds and the formulations of the disclosure are mixed until a homogeneous distribution on seeds is achieved. If appropriate, the seeds may then be dried.

The disclosure also relates to seeds coated with the formulations of the disclosure. Optionally, the seeds are treated in a state in which it is sufficiently stable for no damage to occur in the course of treatment. In general, seeds can be treated at any time between harvest and shortly after sowing. It is customary to use seeds which have been separated from the plant and freed from cobs, shells, stalks, coats, hairs or the flesh of the fruits. For example, it is possible to use seeds which have been harvested, cleaned and dried down to a moisture content of less than 15% by weight. Alternatively, it is also possible to use seeds which, after drying, for example, have been treated with water and then dried again, or seeds just after priming, or seeds stored in primed conditions or pre-germinated seeds, or seeds sown on nursery trays, tapes or paper.

The amount of the formulations of the disclosure applied to the seeds is typically such that the germination of the seed is not impaired, or that the resulting plant is not damaged. The intrinsic phenotypes of transgenic plants should also be taken into consideration when determining the amount of the formulations of the disclosure to be applied to the seed in order to achieve optimum seed and germinating plant protection with a minimum amount of active ingredients being employed.

The formulations of the disclosure can be applied as such, directly to the seeds, i.e., without the use of any other components and without having been diluted. Also, the composition of the disclosure can be applied to the seeds.

The formulations of the disclosure are suitable for protecting seeds of any plant variety. Exemplary seeds are that of cereals (such as wheat, barley, rye, millet, triticale, and oats), oilseed rape, maize, cotton, soybean, rice, potatoes, sunflower, beans, coffee, peas, beet (e.g., sugar beet and fodder beet), peanut, vegetables (such as tomato, cucumber, onions and lettuce), lawns and ornamental plants.

The formulations of the disclosure can be used for treating transgenic seeds, in particular seeds of plants capable of expressing a polypeptide or protein which acts against pests, herbicidal damage or abiotic stress, thereby increasing the protective effect. Seeds of plants capable of expressing a polypeptide or protein which acts against pests, herbicidal damage or abiotic stress may contain at least one heterologous gene which allows the expression of said polypeptide or protein. These heterologous genes in transgenic seeds may originate, for example, from microorganisms of the species Bacillus, Rhizobium, Pseudomonas, Serratia, Trichoderma, Clavibacter, Glomus or Gliocladium. These heterologous genes preferably originate from Bacillus sp., in which case the gene product is effective against the European corn borer and/or the Western corn rootworm. Particularly preferably, the heterologous genes originate from Bacillus thuringiensis.

The disclosure further provides formulations, and application forms prepared from them, as crop protection agents and/or pesticidal agents, such as drench, drip and spray liquors, comprising at least one of the active compounds of the disclosure. The application forms may comprise further crop protection agents and/or pesticidal agents, and/or activity-enhancing adjuvants such as penetrants, examples being vegetable oils such as, for example, rapeseed oil, sunflower oil, mineral oils such as, for example, liquid paraffins, alkyl esters of vegetable fatty acids, such as rapeseed oil or soybean oil methyl esters, or alkanol alkoxylates, and/or spreaders such as, for example, alkylsiloxanes and/or salts, examples being organic or inorganic ammonium or phosphonium salts, examples being ammonium sulphate or diammonium hydrogen phosphate, and/or retention promoters such as dioctyl sulphosuccinate or hydroxypropylguar polymers and/or humectants such as glycerol and/or fertilizers such as ammonium, potassium or phosphorous fertilizers, for example.

### EXAMPLES

### Example 1: Preparation of an Ultra-High Load Agrochemical Formulation

Clothianidin TC (284.53 g) was combined with surfactants (47.42 g), antifreeze (20.75 g), biocides (2.61 g), antifoaming agents (1.48 g), and water (235.98 g) to form a first mixture. The first mixture was then homogenized using an overhead mixer to form a first homogenized mixture. The first homogenized mixture was bead milled under wet conditions at 30-35° C. using glass beads (75-80% load) with a diameter of 0.75 mm to 1.00 mm at 2500 rpm until a D90 particle size of 5 μm was achieved, thereby providing a first mill base. Subsequently, Clothianidin TC (368.74 g) was added to the first mill base (592.76 g) and homogenized to form a second homogenized mixture. The second homogenized mixture was bead milled (30-35° C., 45% load, 0.75-1.0 mm glass beads, 2500 rpm) to a D90 particle size of 5 μm resulting in the second mill base. In a separate vessel a surfactant solution in water (3.76 g surfactant; 33.80 g water) was prepared and then combine with xanthan gum (0.94 g) to form a third mixture. The third mixture was homogenized by overhead mixing to create an aqueous slurry. The aqueous slurry (38.5 g) was combined with the second mill base (961.50 g) to form the agrochemical formulation having a final concentration of 65.33% (w/w) (about 800 g/L) Clothianidin TC, based on the total weight of the agrochemical formulation.

Thus, example 1 shows the preparation of an agrochemical formulation of the disclosure.

### Example 2: Preparation of an Ultra-High Load Agrochemical Formulation

Clothianidin TC (70% of total in the final formulation) was combined with the same surfactants and auxiliary agents as Example 1, and water to form a first mixture. The first mixture was then homogenized using an overhead mixer to form a first homogenized mixture. The first homogenized mixture was colloid milled at 8000 rpm, 0.159 mm gap, and 30-35° C. until a D50 particle size of 40 μm was achieved, thereby providing a first mill base. Subsequently, Clothianidin TC (30% of total in the final formulation) was added to the first mill base and homogenized to form a second homogenized mixture. The second homogenized mixture was passed through the colloid mill one to two times followed by bead milling (45% load, 0.75-1.0 mm glass beads, 2500 rpm) to a D90 particle size of 6 μm resulting in the second mill base. In a separate vessel a surfactant solution in water (3.76 g surfactant; 33.80 g water) was prepared and then combine with xanthan gum (0.94 g) to form a third mixture. The third mixture was homogenized by overhead mixing to create an aqueous slurry. The aqueous slurry was combined with the second mill base to form the agrochemical formulation having a final concentration of about 65% (w/w) (about 885 g/L) Clothianidin TC, based on the total weight of the agrochemical formulation.

Thus, example 2 shows the preparation of an agrochemical formulation of the disclosure.

### Example 3: Preparation of an Ultra-High Load Agrochemical Formulation

Fluopyram TC (222 g) was combined with surfactants (20.9 g), antifreeze (19.9 g), biocides (1.0 g), antifoaming agents (1.48 g), and water (235.98 g) to form a first mixture. The first mixture was then homogenized using an overhead mixer to form a first homogenized mixture. The first homogenized mixture was bead milled under wet conditions at 30-35° C. using glass beads (60% load) with a diameter of 0.75 mm to 1.00 mm at 2500 rpm until a D90 particle size of 6 μm was achieved, thereby providing a first mill base. Subsequently, Fluopyram TC (78.3 g) and Mefentrifluconazole TC (32 g) were added to the first mill base and homogenized to form a second homogenized mixture. The second homogenized mixture was bead milled (30-35° C., 60% load, 0.75-1.0 mm glass beads, 2500 rpm) to a D90 particle size of 6 μm resulting in the second mill base. In a separate vessel a 10% mixture of Methocel k200 M surfactant in propylene glycol was prepared. The surfactant mixture (1.38 g) was added to the second mill base and homogenized using an overhead mixing to form the agrochemical formulation having a final concentration of 66.46% (w/w) (about 850 g/L) Fluopyram and Mefentrifluconazole, based on the total weight of the agrochemical formulation.

### Example 4: Preparation of Agrochemical Formulations

Two agrochemical formulations were prepared according to methods known in the art. Formulation A is an agrochemical formulation not of the disclosure having a concentration of Clothianidin TC of about 600 g/L. Formulation B is an agrochemical formulation not of the disclosure having a concentration of Clothianidin TC of about 750 g/L.

Briefly, Formulation A was prepared by combining Clothianidin TC, surfactant, water, and optional auxiliary agents to form a first mixture. The first mixture was homogenized with an overhead mixer at 500 rpm and subsequently bead milled at 30-35° C. using glass beads (75-80% bead load) with a diameter of 0.75 mm to 1.00 mm at 2500 rpm until a D90 particle size of 5 μm was achieved. The sample was collected in a separate vessel and a 2% xanthan gum slurry in water was added and homogenized at 500 rpm for 1 hour. The final mixture contained 48% w/w (about 600 g/L) Clothianidin TC, based on the total weight of the agrochemical formulation.

Formulation B was prepared in the same way as Formulation A, except that the amount of Clothianidin included in the mixture provided a final formulation having 57.28% w/w (about 750 g/L) Clothianidin TC, based on the total weight of the agrochemical formulation.

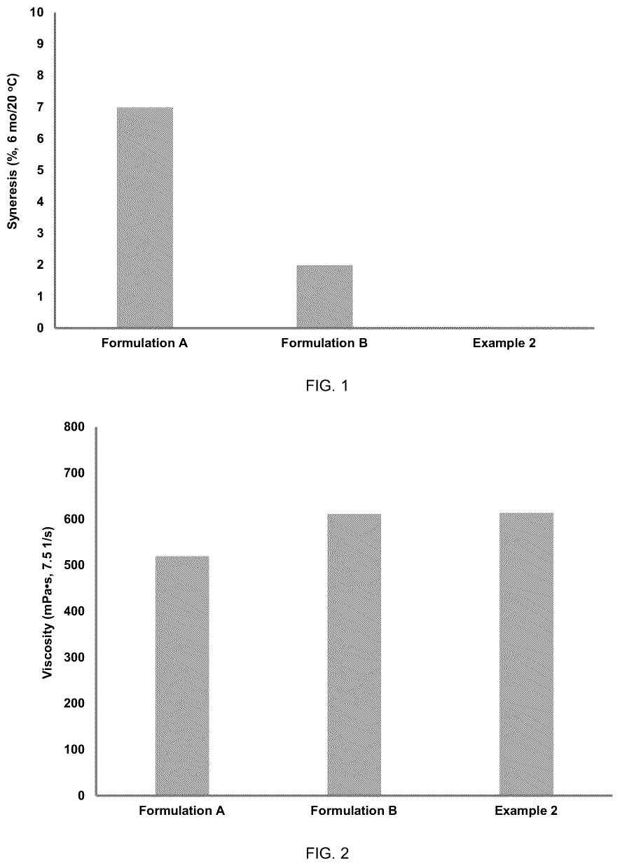

Syneresis and sedimentation of each of Formulation A, Formulation B, and the formulation prepared in Example 2 were monitored over 6 months. Syneresis is provided as a percentage and is determined by measuring the height of the solids at t=0 (Hₜ₌₀) as well as different time points (Hₜ₌ₓ), for example, at least t=4 weeks and t=26 weeks. The percent syneresis at a given point in time is then determined as follows: % Syneresis=[(Hₜ₌₀−Hₜ₌ₓ)/Hₜ₌₀]×100. The results are shown in FIG. 1. As shown in FIG. 1, after storage for 6 months, Formulations A and B demonstrated syneresis (about 7% and 2%, respectively) while the formulation of Example 2 demonstrated significantly improved syneresis (0%). The viscosity of the formulations was also measured after agitation. As shown in FIG. 2, after agitation, the formulation of Example 2 is in the form of a flowable fluid having a viscosity similar to that of Formulation B.

Accordingly, Example 4 demonstrates that formulations of the disclosure prepared by the methods of the disclosure demonstrate improved syneresis at higher concentrations of agrochemical active agents than formulations prepared by known methods, while maintaining the ability to be provided as a flowable fluid.

### Example 5: Method for Preparing an Ultra High Load Formulation Comprising 2 or More Active Ingredients

Briefly, Formulation C was prepared by combining Clothianidin TC, surfactant, water, and optional auxiliary agents to form a first mixture. The first mixture was homogenized with an overhead mixer at 500 rpm and subsequently bead milled at 30-35° C. using glass beads (75-80% bead load) with a diameter of 0.75 mm to 1.00 mm at 2500 rpm until a D90 particle size of 5 μm was achieved. The sample was collected in a separate vessel and Bacillus Firmus slurry in water was added and homogenized at 500 rpm for 1 hour. The final mixture contained 40% w/w Clothianidin TC and 10% Bacillus Firmus or approximately 610 g/L, based on the total weight of the agrochemical formulation.

Briefly, Formulation D was prepared by combining Fluopyram TC, surfactant, water, and optional auxiliary agents to form a first mixture. The first mixture was homogenized with an overhead mixer at 500 rpm and subsequently bead milled at 30-35° C. using glass beads (75-80% bead load) with a diameter of 0.75 mm to 1.00 mm at 2500 rpm until a D90 particle size of 5 μm was achieved. The sample was collected in a separate vessel and a 2% xanthan gum slurry in water was added and homogenized at 500 rpm for 1 hour. The final mixture contained 48% w/w (about 600 g/L) Fluopyram TC, based on the total weight of the agrochemical formulation.

Briefly, Formulation E was prepared by combining Fluopyram TC, surfactant, water, and optional auxiliary agents to form a first mixture. The first mixture was homogenized with an overhead mixer at 500 rpm and subsequently bead milled at 30-35° C. using glass beads (75-80% bead load) with a diameter of 0.75 mm to 1.00 mm at 2500 rpm until a D90 particle size of 5 μm was achieved. The sample was collected in a separate vessel and a 2% xanthan gum slurry in water was added and homogenized at 500 rpm for 1 hour. The final mixture contained 57.25% w/w (about 720 g/L) Fluopyram TC, based on the total weight of the agrochemical formulation.

The composition described in Table 2 represents an exemplary formulation according to the present invention. Mill base 1a was obtained by combining Fluopyram TC 1 with surfactants, antifreeze, biocides, antifoaming agents, and water (Table 4). Mill base 1a was then homogenized using an overhead mixer and bead milled under wet conditions using glass beads (65% load) with a diameter of 0.75 mm to 1.00 mm at 2500 rpm until a particle size of 10 μm (D90) was achieved. Subsequently, Fluopyram TC 2 and Mefentrifluconazole TC was added to mill base 1a (Table 5), homogenized, and bead milled (65% load, 0.75-1.0 mm glass beads, 2500 rpm) to a final particle size of 6 μm (D90) resulting in mill base 1b. In a separate vessel Methocel K200M was combine with propylene glycol (Table 3) and homogenized by overhead mixing to create a slurry. A final concentration of 64.86 w/w % was achieved by combining the Methocel K200M slurry, mill base 1b, and anhydrous citric acid as described in Table 6.

TABLE 2

| | | | Mass |
|---|---|---|---|
| Entry | Component | w/w % | (g) |
| 1 | Flupyram TC (100%) | 58.66 | 586.60 |
| 2 | Mefentrifluconazole TC (100%) | 6.20 | 62.00 |
| 3 | Propylene Glycol | 4.71 | 47.10 |
| 4 | Atlox 4913 | 2.22 | 22.20 |
| 5 | Pluronic F127 | 1.11 | 11.10 |
| 6 | Morwet D425 | 0.37 | 3.70 |
| 7 | Gerapon T36 | 0.73 | 7.30 |
| 8 | Proxel GXL (20%) | 0.17 | 1.70 |
| 9 | Kathon CG/ICP | 0.07 | 0.70 |
| 10 | Antifoam 8830 Food Grade | 0.17 | 1.70 |
| 11 | Methocel K200M | 0.03 | 0.25 |
| 12 | Anhydrous Citric Acid | 0.06 | 0.60 |
| 13 | Water | 25.51 | 255.05 |

| | | |
|---|---|---|
| Total | 100.00 | 1000.00 |

TABLE 3
10% Methocel in Propylene Glycol Slurry

| | | | Mass |
|---|---|---|---|
| Entry | Component | w/w % | (g) |
| 1 | Propylene Glycol | 90.00 | 2.25 |
| 2 | Methocel K200M | 10.00 | 0.25 |

| | | |
|---|---|---|
| Total | 100.00 | 2.50 |

TABLE 4
Mill base 1a

| | | | Mass |
|---|---|---|---|
| Entry | Component | w/w % | (g) |
| 1 | Flupyram TC 1 (100%) | 57.40 | 469.28 |
| 2 | Propylene Glycol | 5.49 | 44.85 |
| 3 | Atlox 4913 | 2.72 | 22.20 |
| 4 | Pluronic F127 | 1.36 | 11.10 |
| 5 | Morwet D425 | 0.45 | 3.70 |
| 6 | Gerapon T36 | 0.89 | 7.30 |
| 7 | Proxel GXL (20%) | 0.21 | 1.70 |
| 8 | Kathon CG/ICP | 0.09 | 0.70 |
| 9 | Antifoam 8830 Food Grade | 0.21 | 1.70 |
| 10 | Water | 31.20 | 255.05 |

| | | |
|---|---|---|
| Total | 100.00 | 817.58 |

TABLE 5
Mill base 1b

| | | | Mass |
|---|---|---|---|
| Entry | Component | w/w % | (g) |
| 1 | Mill base 1a | 82.01 | 817.58 |
| 2 | Flupyram TC 2 (100%) | 11.77 | 117.32 |
| 3 | Mefentrifluconazole (100%) | 6.22 | 62.00 |

| | | |
|---|---|---|
| Total | 100.00 | 996.90 |

TABLE 6
Post addition

| | | | Mass |
|---|---|---|---|
| Entry | Component | w/w % | (g) |
| 1 | Mill base 1b | 99.69 | 996.90 |
| 2 | Methocel 10% Slurry | 0.25 | 2.50 |
| 3 | Anhydrous Citric Acid | 0.06 | 0.60 |

| | | |
|---|---|---|
| Total | 100.00 | 1000.00 |

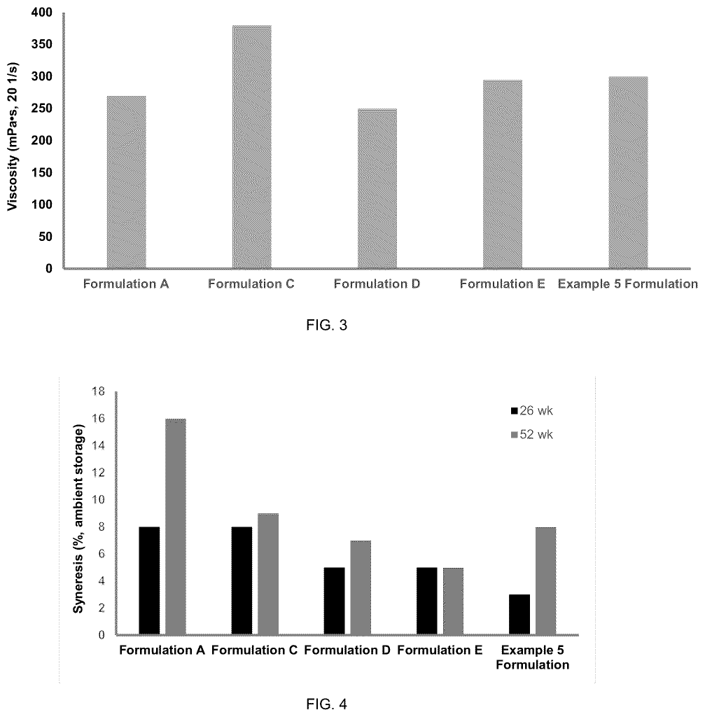

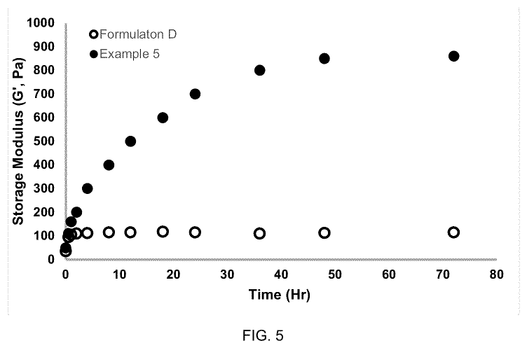

Viscosity, storage modulus (G′) and syneresis of this Formulation was analyzed. Viscosity and storage modulus were measured on an Anton Paar 302e rheometer using a double gap geometry. Viscosity and storage modulus measurements were performed at 20 1/s and 0.5 Hz (72 hr), respectively. Syneresis was determined by dividing the length of the liquid supernatant phase and dividing by the length of suspension phase. Table 6 shows the viscosity and syneresis results while Table 7 shows the storage modulus (G′) data for the formulations. FIGS. 3 and 4 shows the viscosity and syneresis results for Formulations A, C, D, E and Example 5 Formulation. FIG. 5 shows the storage modulus (G′) data for the Formulation D and Example 5 Formulation

TABLE 6

| | Active | | | |
|---|---|---|---|---|
| | Loading | Viscosity | Syneresis | |
| Formulation | (g/L) | (mPa · s, 20 1/s) | 26 wk | 52 wk |
| Formulation A | 600 | 270 | 8 | 16 |
| Formulation C | 610 | 380 | 8 | 9 |
| Formulation D | 600 | 250 | 5 | 7 |
| Formulation E | 720 | 295 | 5 | 5 |
| Example 5 | 840 | 300 | 3 | 8 |
| Formulation | | | | |

TABLE 7

| | Time | Formulation | Example |
|---|---|---|---|
| Entry | (hr) | D | 5 |
| 1 | 0 | 35 | 50 |
| 2 | 0.5 | 95 | 110 |
| 3 | 1 | 105 | 160 |
| 4 | 2 | 110 | 200 |
| 5 | 4 | 112 | 300 |
| 6 | 8 | 115 | 400 |
| 7 | 12 | 115 | 500 |
| 8 | 18 | 118 | 600 |
| 9 | 24 | 115 | 700 |
| 10 | 36 | 110 | 800 |
| 11 | 48 | 113 | 850 |
| 12 | 72 | 115 | 860 |

The foregoing description is given for clearness of understanding only, and no unnecessary limitations should be understood therefrom, as modifications within the scope of the invention may be apparent to those having ordinary skill in the art.

All patents, publications and references cited herein are hereby fully incorporated by reference. In case of conflict between the present disclosure and incorporated patents, publications and references, the present disclosure should control.

1. A method of forming an agrochemical formulation comprising:
(a) homogenizing a first mixture comprising at least one agrochemical active agent in water to form a first homogenized mixture;
(b) forming a first mill base by:
(i) bead milling the first homogenized mixture to form first particles having a D90 particle size of about 1-75 microns; or
(ii) colloid milling the first homogenized mixture to form first particles having a D50 particles size of about 1-75 microns;
(c) homogenizing a second mixture comprising at least one agrochemical active agent and the first mill base to form a second homogenized mixture;
(d) bead milling the second homogenized mixture to form a second mill base including second particles having a D90 particles size of about 1-75 microns;
(e) homogenizing a third mixture comprising an aqueous surfactant solution and a thickening agent to form a slurry; and
(f) combining the slurry with the second mill base to form an agrochemical formulation comprising 57-76% (w/w) of the agrochemical active agent, based on the total weight of the formulation, thereby forming the agrochemical formulation;
wherein, the first mixture comprises 20-70% (w/w) of the at least one agrochemical active agent with the balance including water and optionally a surfactant, an antifreeze, a biocide, an antifoaming agent, or a combination thereof; and the second mixture comprises 10-50% (w/w) of the at least one agrochemical active agent, based on the total weight of the second mixture.

2. The method of claim 1, wherein the at least one agrochemical active agent in step (a) and the at least one agrochemical active agent in step (c) are the same agrochemical active agents.

3. The method of claim 1, wherein the at least one agrochemical active agent in step (a) and the at least one agrochemical active agent in step (c) are different agrochemical active agents.

4. The method of claim 1, wherein the first mixture and second mixture are substantially free of a surfactant.

5. The method of claim 1, wherein the active agent has a density in a range of about 1.0 and 2.0 g/mL.

6. The method of claim 1, wherein the active agent has a melting point above about 50° C.

7. The method of claim 1,
wherein the active agent has a solubility in water of less than about 1000 mg/L.

8. The method of claim 1, wherein the bead milling, colloid milling, or combinations thereof occurs in a mill with a controlled temperature set in a range of about 1° C. to about 60° C., or about 30° C. to about 45° C., or about 30° C. to about 35° C.

9. The method of claim 1, wherein the concentration of the agrochemical active agent in the agrochemical formulation is at least about 750 g/L.

10. (canceled)

11. The method of claim 1, wherein the agrochemical formulation is in the form of a gel.

12. The method of claim 1, wherein the bead milling in step (b) comprises a load of beads in the range of about 60%-90%, about 70%-90%, or about 75%-85%.

13. The method of claim 1, wherein the bead milling in step (d) comprises a load of beads in the range of about 25%-70%, about 30%-60%, about 35%-50%, or about 40%-50%.

14. The method of claim 1, wherein the agrochemical active agent comprises an insecticide selected from the group of abamectin, chlorantraniliprole, clothianidin, cyantraniliprole, ethiprole, fipronil, flubendiamide, flupyradifurone, imidacloprid, methiocarb, spinetoram, spinosad, sulfoxaflor, tefluthrin, thicloprid, thiamethoxam, and thiodicarb.

15. The method of claim 14, wherein the insecticide comprises clothianidin.

16. The method of claim 1, wherein the at least one agrochemical active agent of step (a) and/or (c) comprises clothianidin.

17. The method of claim 1, wherein the agrochemical active agent comprises a fungicide selected from the group of azoxystrobin, beta-cyfluthrin, carbendazim, carbendazim, cyproconazole, epoxiconazole, fenamidone, fluazinam, fludioxinil, fluopyram, fluoxastrobin, fluquinconazole, ipconazole, iprodione, isotianil, mefentrifluconazole, metalaxyl, metalaxyl-M, metominostrobin, pencycuron, penflufen, picarbutrazox, picoxystrobin, procymidone, propiconazole, prothioconazole, pyraclostrobin, tebuconazole, triadimenol, and trifloxystrobin.

18. The method of claim of claim 3, wherein the agrochemical active agents comprise at least Mefentrifluconazole and Fluopyram.

19. The method of claim 1, wherein the surfactant in the first mixture, the second mixture, the third mixture, or a combination thereof comprises a nonionic surfactant, an anionic surfactant, or a combination thereof.

20. The method of claim 19, wherein the nonionic surfactant comprises an alkoxylate surfactant, a polymeric surfactant, or a combination thereof.

21. The method of claim 20, wherein the alkoxylate surfactant comprises an alcohol, alkylphenol, amine, amide, arylphenol, fatty acid or fatty acid ester, or a combination of the foregoing; and the alkoxylate surfactant has been alkoxylated with 1 to 50 equivalents.

22. The method of claim 20, wherein the polymeric surfactant comprises a block polymer of the A-B or A-B-A type comprising blocks of polyethylene oxide and polypropylene oxide, a block copolymer of the A-B-C type comprising alkanol, polyethylene oxide, and polypropylene oxide, a comb polymer, or a combination thereof.

23. The method of claim 20, wherein the polymeric surfactant comprises a poloxamer or an acrylic copolymer.

24. The method of claim 19, wherein the anionic surfactant comprises a sulfonate or a carboxylate.

25. The method of claim 24, wherein the sulfonate comprises a lignin sulfonate, a sulfonate of condensed naphthalenes, or a salt thereof.

26. The method of claim 24, wherein the carboxylate comprises an alkyl carboxylate, an alkylphenol ethoxylate, a polycarboxylic acid, or a carboxylated alcohol.

27. The method of claim 1, wherein the agrochemical formulation comprises at least 65% (w/w) of the agrochemical active agent, based on the total weight of the formulation.

28. An agrochemical formulation produced by the method of claim 1.

29. An agrochemical formulation comprising:
at least about 57 to about 76% (w/w) of at least one agrochemical active agent, based on the total weight of the formulation, dispersed in a mixture of water, an aqueous surfactant, and thickening agent,
wherein the agrochemical formulation is in the form of a shear thinning gel.

30. The agrochemical formulation of claim 29, wherein the agrochemical formulation has a viscosity of greater than 2000 cP.

31. The agrochemical formulation of claim 29, wherein when agitated, the viscosity of the agrochemical formulation is reduced to a viscosity in a range of about 200 cP to about 1000 cP, or about 400 cP to about 800 cP.

32. The agrochemical formulation of claim 29, wherein the agrochemical active agent has a density in a range of about 1.0 and 2.0 g/mL.

33. The agrochemical formulation of claim 29, wherein the agrochemical active agent has a melting point above about 50° C.

34. The agrochemical formulation of claim 29, wherein the agrochemical active agent has a solubility in water of less than about 1000 mg/L.

35. The agrochemical formulation of claim 29, wherein the concentration of the agrochemical active agent in the agrochemical formulation is at least about 750 g/L.

36. The agrochemical formulation of claim 35, wherein the concentration of the agrochemical active agent in the agrochemical formulation is in a range of about 750 g/L to about 1000 g/L, about 800 g/L to about 950 g/L, about 800 g/L to about 900 g/L, or about 825 g/L to about 875 g/L.

37. The agrochemical formulation of claim 29, wherein the agrochemical active agent comprises an insecticide selected from the group of abamectin, chlorantraniliprole, clothianidin, cyantraniliprole, ethiprole, fipronil, flubendiamide, flupyradifurone, imidacloprid, methiocarb, spinetoram, spinosad, sulfoxaflor, tefluthrin, thicloprid, thiamethoxam, and thiodicarb.

38. The agrochemical formulation of claim 37, wherein the insecticide comprises clothianidin.

39. The agrochemical formulation of claim 29, wherein the agrochemical active agent comprises a fungicide selected from the group of azoxystrobin, beta-cyfluthrin, carbendazim, carbendazim, cyproconazole, epoxiconazole, fenamidone, fluazinam, fludioxinil, fluopyram, fluoxastrobin, fluquinconazole, ipconazole, iprodione, isotianil, Mefentrifluconazole, metalaxyl, metalaxyl-M, metominostrobin, pencycuron, penflufen, picarbutrazox, picoxystrobin, procymidone, propiconazole, prothioconazole, pyraclostrobin, tebuconazole, triadimenol, and trifloxystrobin.

40. The agrochemical formulation of claim 29, wherein the agrochemical active agents comprise at least Mefentrifluconazole and Fluopyram.

41. The agrochemical formulation of claim 29, wherein the surfactant comprises a nonionic surfactant, an anionic surfactant, or a combination thereof.

42. The agrochemical formulation of claim 29, wherein the nonionic surfactant is an alkoxylate surfactant, a polymeric surfactant, or a combination thereof.

43. The agrochemical formulation of claim 42, wherein the alkoxylate surfactant comprises an alcohol, alkylphenol, amine, amide, arylphenol, fatty acid or fatty acid ester, or a combination of the foregoing; and the alkoxylate surfactant has been alkoxylated with 1 to 50 equivalents.

44. The agrochemical formulation of claim 43, wherein the polymeric surfactant is a block polymer of the A-B or A-B-A type comprising blocks of polyethylene oxide and polypropylene oxide, a block copolymer of the A-B-C type comprising alkanol, polyethylene oxide, and polypropylene oxide, a comb polymer, or a combination thereof.

45. The agrochemical formulation of claim 43, wherein the polymeric surfactant comprises a poloxamer, an acrylic copolymer, or a combination thereof.

46. The agrochemical formulation of claim 41, wherein the anionic surfactant comprises a sulfonate, a carboxylate, or a combination thereof.

47. The agrochemical formulation of claim 46, wherein the sulfonate comprises a lignin sulfonate, a sulfonate of condensed naphthalenes, or a salt thereof.

48. The agrochemical formulation of claim 46, wherein the carboxylate comprises an alkyl carboxylate, an alkylphenol ethoxylate, a polycarboxylic acid, a carboxylated alcohol, or a combination thereof.

49. The agrochemical formulation of claim 29, comprising at least 65% (w/w) of the agrochemical active agent, based on the total weight of the formulation.

50. An article for dispensing the agrochemical formulation of claim 29, comprising:
a container fitted with a mixing blade; and
the agrochemical formulation of any one of claim 29 provided in the container and in contact with the mixing blade,
wherein the mixing blade is configured to facilitate a phase transition of the agrochemical formulation from a gel to a flowable fluid.

51. A kit comprising:
a container fitted with a mixing blade; and
the agrochemical formulation of claim 29.

52. A method of treating a substrate with an agrochemical formulation, comprising:
applying the agrochemical formulation of claim 29 to the substrate.

53. The method of claim 52, further comprising agitating the agrochemical formulation to facilitate a phase transition of the agrochemical formulation from a gel to a flowable fluid.
